(19) United States
(12) Patent Application Publication
(10) Pub. No.: US 2013/0081808 A1
(43) Pub. Date: Apr. 4, 2013

(54) HYDROCARBON RECOVERY FROM BITUMINOUS SANDS WITH INJECTION OF SURFACTANT VAPOUR

(71) Applicants: Khalil Zeidani, Calgary (CA); Subodh Gupta, Calgary (CA)

(72) Inventors: Khalil Zeidani, Calgary (CA); Subodh Gupta, Calgary (CA)

(21) Appl. No.: 13/631,673

(22) Filed: Sep. 28, 2012

Related U.S. Application Data
(60) Provisional application No. 61/541,712, filed on Sep. 30, 2011.

(51) Int. Cl. C09K 8/592; E21B 43/24; E21B 43/16

(52) U.S. Cl. CPC C09K 8/592; E21B 43/16; E21B 43/2406
USPC 166/272.4; 166/268; 166/272.1; 166/52; 507/202

(57) ABSTRACT

A process of increasing recovery rate of hydrocarbon from a reservoir of bituminous sands is disclosed. The process comprises softening bitumen in a region in the reservoir to generate a fluid comprising a hydrocarbon, to allow the fluid to drain by gravity from the region into a production well below the region for recovery of the hydrocarbon; and providing vapour of a compound to the region, and allowing the compound to disperse and condense in the region. The compound is represented by

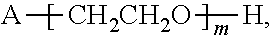

wherein (i) m is 1, and A is —NH₂ or —N(H)CH₂CH₂OH; or (ii) m is 1 or greater than 1, and A is —OR₁, R₁ being an alkyl group. A mixture comprising steam and vapour of the compound for injection into the reservoir and a system for recovery of hydrocarbon from the reservoir are also disclosed.

### CROSS-REFERENCE TO RELATED APPLICATION

This application claims the benefit of, and priority from, U.S. patent application Ser. No. 61/541,712, filed Sep. 30, 2011, and entitled “Hydrocarbon Recovery from Bituminous Sands with Injection of Surfactant Vapour,” the entire contents of which are incorporated herein by reference.

### FIELD

The present invention relates generally to hydrocarbon recovery from reservoirs of bituminous sands, and particularly to recovery of hydrocarbons from reservoirs of bituminous sands with the use of a surfactant.

### BACKGROUND

Hydrocarbon resources such as bituminous sands (also commonly referred to as oil sands or tar sands) present significant technical and economic recovery challenges due to the hydrocarbons in the bituminous sands having high viscosities at reservoir temperature. Steam-Assisted Gravity Drainage (SAGD) is an example of an in situ steam injection-based hydrocarbon recovery process used to extract heavy oil or bitumen from a reservoir of bituminous sands by reducing viscosity of the oil via steam injection.

A SAGD system typically includes at least one pair of steam injection and oil production wells (a “well pair”) located in a reservoir of bituminous sands. The injection (upper) well has a generally horizontal section used for injecting a fluid such as steam into the reservoir for softening the bitumen in a region of the reservoir and reducing the viscosity of the bitumen. Heat is transferred from the injected steam to the reservoir formation, which softens the bitumen. The softened bitumen and condensed steam can flow and drain downward due to gravity, thus leaving behind a porous region, which is permeable to gas and steam and is referred to as the steam chamber. Subsequently injected steam rises from the injection well, permeates the steam chamber, and condenses at the edge of the steam chamber. In the process, more heat is transferred to the bituminous sands and the steam chamber grows over time. The mobilized hydrocarbons and condensate that drain downward under gravity are collected by a generally horizontal section of the production well, which is typically disposed below the injection well and from which the hydrocarbons (oil) are (is) produced. Several well pairs may be arranged within the reservoir to form a well pattern or pad. Additional injection or production wells, such as a well drilled using Wedge Well™ technology, may also be provided.

Surfactants are compounds that lower the surface tension of a liquid, the interfacial tension between two liquids, or the interfacial tension between a liquid and a solid. Surfactants may act, for example, as detergents, wetting agents, emulsifiers, foaming agents, or dispersants. A surfactant can be classified according to the composition of its different chemical functional groups. The hydrophilic part of a surfactant is referred to as the head of the surfactant, while the hydrophobic part of a surfactant is referred to as the tail. Surfactants may be ionic, zwitterionic, or non-ionic. An ionic surfactant carries a net positive (cationic) or negative (anionic) charge that is balanced by a counter-ion of the opposite charge, e.g., benzalkonium chloride is cationic with a chloride counter-ion and sodium lauryl sulphate is anionic with a sodium counter-ion. A zwitterionic surfactant possesses a head with two oppositely charged groups, e.g., lecithin, making the surfactant neutral overall.

Unlike an ionic surfactant, a non-ionic surfactant does not dissociate into ions in aqueous solution. E.g., stearyl alcohol, polyethylene glycol tert-octylphenyl ether, and lauryldimethylamine N-oxide are non-ionic surfactants.

One application of surfactants in the field of oil and gas relates to in situ hydrocarbon recovery processes such as, for example, SAGD. In such processes, some surfactants have been used alone or in combination with other chemical additives to reduce the oil-water interfacial tension and alter the wettability of the reservoir with the goal of enhancing recovery. However, challenges remain in connection with applications of surfactants under in situ conditions due to, for example, the elevated temperatures under which such processes are effected, compatibility issues with salt and thermal stability of the surfactants.

### SUMMARY

In accordance with an aspect of the present invention, there is provided a process of increasing recovery rate of hydrocarbon from a reservoir of bituminous sands. The process comprises softening bitumen in a region in the reservoir to generate a fluid comprising a hydrocarbon, to allow the fluid to drain by gravity from the region into a production well below the region for recovery of the hydrocarbon; and providing vapour of a compound to the region, and allowing the compound to disperse and condense in the region. The compound may be presented by

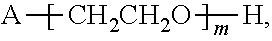

wherein (i) m is 1, and A is —NH₂ or —N(H)CH₂CH₂OH; or (ii) m is 1 or greater than 1, and A is —OR₁, R₁ being an alkyl group. The vapour of the compound may be provided to the region with steam from an injection well. A solvent may be provided to the region, wherein the solvent may comprise an alkane having at least 3 carbons and the weight ratio of the solvent to the steam is less than 1%. A tertiary acetylenic diol may also be provided to the region.

The compound may be a primary, secondary, or tertiary alcohol ethoxylate. The alcohol ethoxylate may have the formula

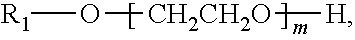

wherein R₁ is a linear or branched alkyl group having more than 5 carbon atoms, and m is greater than 1. The alcohol ethoxylate may have the formula of

C₁₂₋₁₄H₂₅₋₂₉O[CH₂CH₂O]₉H;

C₁₂₋₁₅H₂₅₋₃₁O[CH₂CH₂O]_{2.8}H;

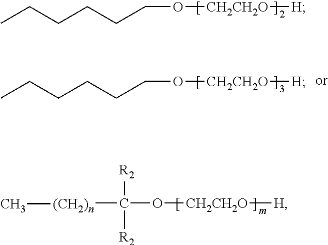

wherein m is 2 or 3, n is 2 or 3, and R₂ is methyl or ethyl. The vapour of the alcohol ethoxylate may be provided to the region at a partial pressure of about 85 kPa to about 590 kPa and a temperature from about 225° C. to about 275° C. Where the compound is an alcohol ethoxylate, the steam may be at a temperature from about 225° C. to about 275° C. in the injection well, and the molar ratio of the vapour of the alcohol ethoxylate to the steam in the injection well may be about 0.03:1 to about 0.1:1. The steam may be at a temperature from about 160° C. to about 310° C. and a pressure of about 600 kPa to 10 MPa in the injection well. The volume ratio of the alcohol ethoxylate to the steam, measured at room temperature on a liquid basis, may be about 10 ppm to about 2000 ppm, or may be about 10 ppm to about 8000 ppm when the alcohol ethoxylate is a secondary alcohol ethoxylate.

In accordance with another aspect of the present invention, there is provided a mixture for injection into a reservoir of bituminous sands to recover hydrocarbon from the reservoir. The mixture comprises steam at a temperature from about 160° C. to about 310° C. and a pressure of about 600 kPa to 10 MPa; and vapour of a compound. The compound may be presented by

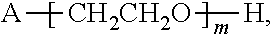

wherein (i) m is 1, and A is —NH₂ or —N(H)CH₂CH₂OH; or (ii) m is 1 or greater than 1, and A is —OR₁, R₁ being an alkyl group. The mixture may further comprise a solvent, wherein the solvent may comprise an alkane having at least 3 carbons and the weight ratio of the solvent to the steam is less than 1%. The mixture may further comprise a tertiary acetylenic diol. The compound may be an alcohol ethoxylate as described in the preceding paragraph. The steam in the mixture may be at a temperature from about 225° C. to about 275° C. and the vapour of the alcohol ethoxylate may have a partial pressure of about 85 kPa to about 590 kPa. The steam may be at a temperature from about 225° C. to about 275° C. and the volume ratio of the alcohol ethoxylate to the steam, measured at room temperature on a liquid basis, may be about 10 ppm to about 2000 ppm, or may be about 10 ppm to about 8000 ppm when the alcohol ethoxylate is a secondary alcohol ethoxylate.

In accordance with another aspect of the present invention, there is also provided a system for recovery of hydrocarbon from a reservoir of bituminous sands. The system comprises an injection well disposed in the reservoir for injecting steam into a region of the reservoir to soften bitumen in the region and generate a fluid comprising a hydrocarbon; a production well disposed in the reservoir below the injection well for receiving the fluid to recover the hydrocarbon; and a conduit in fluid communication with the reservoir, the conduit containing vapour of a compound for injection into the region. The compound may be presented by

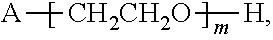

wherein (i) m is 1, and A is —NH₂ or —N(H)CH₂CH₂OH; or (ii) m is 1 or greater than 1, and A is —OR₁, R₁ being an alkyl group. The conduit may be provided in the injection well. The compound may be an alcohol ethoxylate as described above.

In accordance with another aspect of the present invention, there is also provided a process for recovery of hydrocarbon from a reservoir of bituminous sands. The process comprises softening bitumen in a region in the reservoir to generate a fluid comprising a hydrocarbon, wherein the fluid is mobile to drain by gravity from the region into a production well below the region; contacting the bitumen in the region with a first surfactant and a second surfactant to increase mobility of the hydrocarbon in the region, wherein the first surfactant is water soluble and the second surfactant is water insoluble; and producing the hydrocarbon from the fluid drained into the production well. The first surfactant may have a hydrophile-lipophile balance (HLB) greater than about 7.

In accordance with a further aspect of the present invention, there is provided a process for recovery of hydrocarbon from a reservoir of bituminous sands. The process comprises softening bitumen in a region in the reservoir to generate a fluid comprising a hydrocarbon, wherein the fluid is mobile to drain by gravity from the region into a production well below the region; contacting the bitumen in the region with a first surfactant and a second surfactant to increase mobility of the hydrocarbon in the region, wherein the first surfactant has an HLB greater than 8, and the second surfactant has an HLB less than 8; and producing the hydrocarbon from the fluid drained into the production well.

In the processes described in the two immediately preceding paragraphs, the first and second surfactants may be non-ionic. Vapour of the first and second surfactants may be provided to the region at a temperature from about 225° C. to about 275° C. The HLB of the first surfactant may be greater than 9. The HLB of the second surfactant may be less than 5.5. The first surfactant may be an alcohol ethoxylate or a phenol ethoxylate. The phenol ethoxylate may be an alkylphenol ethoxylate. The second surfactant may be a tertiary acetylenic diol. A solvent and steam may be provided to the region, wherein the solvent may comprise an alkane having at least 3 carbons and the weight ratio of the solvent to the steam is less than 1%.

In accordance with another aspect of the present invention, there is provided a mixture for injection into a reservoir of bituminous sands to recover hydrocarbon from the reservoir. The mixture comprises steam at a temperature from about 160° C. to about 310° C. and a pressure of about 600 kPa to 10 MPa; a first surfactant; and a second surfactant, wherein the first surfactant is water soluble and the second surfactant is water insoluble, or wherein the first surfactant has an HLB greater than 8, and the second surfactant has an HLB less than 8. The first and second surfactants may be non-ionic. The mixture may be at a temperature from about 225° C. to about 275° C. The HLB of the first surfactant may be greater than 9. The HLB of the second surfactant may be less than 5.5. The first surfactant may be an alcohol ethoxylate or a phenol ethoxylate. The phenol ethoxylate may be an alkylphenol ethoxylate. The second surfactant may be a tertiary acetylenic diol. The mixture may further comprise a solvent, wherein the solvent may comprise an alkane having at least 3 carbons and the weight ratio of the solvent to the steam is less than 1%.

In accordance with a further aspect of the present invention, there is provided a process for recovery of hydrocarbon from a reservoir of bituminous sands. The process comprises injecting steam into a region in the reservoir to soften bitumen in the region and to generate a fluid comprising a hydrocarbon, wherein the fluid is mobile to drain by gravity from the region into a production well below the region; contacting the bitumen in the region with a surfactant and a solvent to increase mobility of the hydrocarbon in the region, wherein the solvent may comprise an alkane having at least 3 carbon atoms and the weight ratio of the solvent to the steam is less than 1%; and producing the hydrocarbon from the fluid drained into the production well. The weight ratio of the hydrocarbon to water drained into the production well may be less than 2. The solvent may also comprise an alkane having at least 6 carbons. The surfactant may be an alcohol ethoxylate, a phenol ethoxylate, a tertiary acetylenic diol including a tertiary acetylenic diol ethoxylate, an alkylmercaptan ethoxylate, an alkylpropoxy ethoxylate, an amine ethoxylate, an amide ethoxylate, an amino alcohol, or an alcoholamide. The alcohol ethoxylate may be an alcohol ethoxylate as described in the above paragraphs. The phenol ethoxylate may be an alkylphenol ethoxylate. The alkylphenol ethoxylate may have the formula

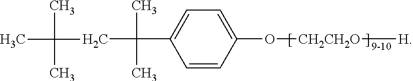

The phenol ethoxylate may have the formula

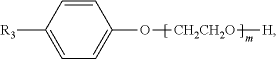

wherein R₃ is hydrogen, or a linear or branched alkyl group, and m is greater than 1, such as a linear or branched alkyl group having more than 2 carbon atoms. The tertiary acetylenic diol may have the formula

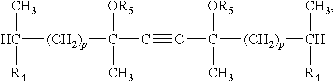

wherein R₄ is hydrogen or methyl; R₅ is hydrogen or hydroxyethyl; and p is 1-3 when R₅ is hydroxyethyl, or less than 3 when R₅ is hydrogen. The tertiary acetylenic diol may also be a tertiary acetylenic diol ethoxylate having the formula

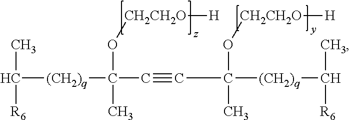

wherein R₆ is hydrogen, or a linear or branched alkyl group, q is greater than 1, and at least one of y and z is greater than or equal to 1. The alkylmercaptan ethoxylate may have the formula

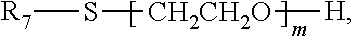

wherein R₇ is a linear or branched C₆C₁₀ alkyl group and m is 2-4. The alkylpropoxy ethoxylate may have the formula

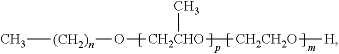

wherein m is 2 or 3, n is 3 or 4, and p is 1 or 2. The amino alcohol may be an ethanolamine such as monoethanolamine, diethanolamine or triethanolamine. The surfactant may comprise vapour of a first non-ionic surfactant and vapour of a second non-ionic surfactant, and wherein (i) the first non-ionic surfactant is water soluble and the second non-ionic surfactant is water insoluble, or (ii) the first non-ionic surfactant has an HLB greater than 8, and the second non-ionic surfactant has an HLB less than 8.

In accordance with another aspect of the present invention, there is provided a mixture for injection into a reservoir of bituminous sands to recover hydrocarbon from the reservoir. The mixture comprises steam at a temperature from about 160° C. to about 310° C. and a pressure of about 600 kPa to 10 MPa; vapour of a non-ionic surfactant; and a solvent, wherein the solvent may comprise an alkane having least 3 carbon atoms and the weight ratio of the solvent to the steam is less than 1%. The solvent may also comprise an alkane having at least 6 carbons. The mixture may be at a temperature from about 225° C. to about 275° C. The surfactant may be an alcohol ethoxylate, a phenol ethoxylate, a tertiary acetylenic diol, an alkylmercaptan ethoxylate, or an alkylpropoxy ethoxylate. The surfactant may comprise a first surfactant and a second surfactant, wherein (i) the first surfactant is water soluble and the second surfactant is water insoluble, or (ii) the first surfactant has an HLB greater than 8, and the second surfactant has an HLB less than 8.

In accordance with another aspect of the present invention, there is provided a process for recovery of hydrocarbon from a reservoir of bituminous sands. The process comprises softening bitumen in a region in the reservoir to generate a fluid comprising a hydrocarbon, to allow the fluid to drain by gravity from the region into a production well below the region for recovery of the hydrocarbon; providing vapour of a non-ionic surfactant to the region, wherein the surfactant may comprise (i) an alkylphenol ethoxylate having a partial pressure from about 60 to about 150 kPa, or (ii) a tertiary acetylenic diol having a partial pressure from about 2400 to about 6300 kPa; condensing and dispersing the surfactant in the region, so as to increase mobility of the hydrocarbon in the region; and producing the hydrocarbon from the fluid drained into the production well. The surfactant may be provided to the region with steam under a steam pressure from about 600 kPa to about 10 MPa at a temperature from about 160° C. to about 310° C. The temperature may be from about 225° C. to about 275° C. The alkylphenol ethoxylate may be as described in the preceding paragraphs. The tertiary acetylenic diol may be as described in the preceding paragraphs.

In the processes described herein, bitumen in a region may be softened by injecting steam or a solvent into the region, or by heating the bitumen in the region.

In accordance with another aspect of the present invention, there is provided a mixture for injection into a reservoir of bituminous sands to recover hydrocarbon from the reservoir. The mixture comprises steam at a temperature from about 160° C. to about 310° C. and a pressure of about 600 kPa to 10 MPa; and vapour of a non-ionic surfactant comprising (i) an alkylphenol ethoxylate having a partial pressure from about 60 to about 150 kPa, or (ii) a tertiary acetylenic diol having a partial pressure from about 2400 to about 6300 kPa. The mixture may be at a temperature from about 225° C. to about 275° C. The alkylphenol ethoxylate may be as described in the preceding paragraphs. The tertiary acetylenic diol may be as described in the preceding paragraphs.

In accordance with a further aspect of the present invention, there is provided a system for recovery of hydrocarbon from a reservoir of bituminous sands. The system comprises an injection well disposed in the reservoir for injecting steam into a region of the reservoir to soften bitumen in the region and generate a fluid comprising a hydrocarbon; a production well disposed in the reservoir below the injection well for receiving the fluid to recover the hydrocarbon; and a conduit in fluid communication with the reservoir, the conduit containing vapour of a non-ionic surfactant comprising (i) an alkylphenol ethoxylate having a partial pressure from about 60 to about 150 kPa, or (ii) a tertiary acetylenic diol having a partial pressure from about 2400 to about 6300 kPa.

In accordance with another aspect of the present invention, there is provided a system for recovery of hydrocarbon from a reservoir of bituminous sands, the system comprising means for softening bitumen in a region of the reservoir of bituminous sands to generate a fluid comprising a hydrocarbon; means for producing the fluid to recover the hydrocarbon; and means for providing vapour of a first surfactant and vapour of a second surfactant to the region, wherein the first surfactant is water soluble and the second surfactant is water insoluble, or wherein the first surfactant has a HLB greater than 8, and the second surfactant has an HLB less than 8.

In accordance with a further aspect of the present invention, there is provided a system for recovery of hydrocarbon from a reservoir of bituminous sands. The system comprises an injection well disposed in the reservoir for injecting steam into a region of the reservoir to soften bitumen in the region and generate a fluid comprising a hydrocarbon; a production well disposed in the reservoir below the injection well for receiving the fluid to recover the hydrocarbon; and means for providing a solvent and a surfactant to the region, wherein the solvent may comprise an alkane having least 3 carbon atoms and the weight ratio of the solvent to the steam is less than 1%.

In accordance with a further aspect of the present invention, there is provided a process of increasing recovery rate of hydrocarbon from a reservoir of bituminous sands. The process comprises softening bitumen in a region in the reservoir to generate a fluid comprising a hydrocarbon, to allow the fluid to drain by gravity from the region into a production well below the region for recovery of the hydrocarbon; and providing vapour of an ethanolamine to the region, and allowing the ethanolamine to disperse and condense in the region. The ethanolamine may be triethanolamine.

Other aspects, features, and embodiments of the present invention will become apparent to those of ordinary skill in the art upon review of the following description of specific embodiments of the invention in conjunction with the accompanying figures.

### BRIEF DESCRIPTION OF THE DRAWINGS

In the figures, which illustrate, by way of example only, embodiments of the present invention:

FIGS. 1A and 1B are schematic diagrams illustrating a Steam-Assisted Gravity Drainage (SAGD) arrangement according to an embodiment of the invention;

FIG. 2 is a data graph showing interfacial tension (IFT) measurements of sample surfactants in water-refined oil;

FIG. 3 is a data graph showing IFT measurements from sample surfactants in a water-bitumen mixture;

FIG. 4 is a data graph showing IFT measurements from sample surfactants in a water-bitumen mixture;

FIG. 5 is a bar graph showing results of the effect of temperature on molecular weight (MW) of sample surfactants;

FIG. 6 is a data graph showing vapour pressure measurements of sample surfactants;

FIG. 7 is a data graph showing IFT measurements from a vapourization study of a sample surfactant;

FIG. 8 is a data graph showing IFT measurements from a vapourization study of a sample surfactant;

FIG. 9 is a data graph showing IFT measurements from a vapourization study of a sample surfactant;

FIG. 10 is a data graph showing IFT measurements from a vapourization study of a sample surfactant;

FIG. 11 is a data graph showing IFT measurements from a vapourization study of the sample surfactant of FIG. 9; and

FIG. 12 is a data graph showing percent recovered original oil in place (OOIP) with steam or steam with sample surfactants.

### DETAILED DESCRIPTION

According to an embodiment, a method of recovery of hydrocarbons from a reservoir of bituminous sands is to deliver a suitable surfactant in vapour form into a region of bituminous sands where bitumen in the region is softened and a fluid mixture containing hydrocarbons is generated. The surfactant is selected such that it can condense in the region, disperse or dissolve in the fluid mixture, and cause an increase in the mobility of one or more hydrocarbons in the region, or an increase in flow rate of hydrocarbons in the fluid mixture through the reservoir formation. As a result, hydrocarbons may be moved at a faster rate, or more hydrocarbons may be moved, to a production well, such as by gravity drainage, thus improving production performance.

Production performance may be improved when a higher amount of hydrocarbons is produced within a given period of time, or with a given amount of injected steam or solvent depending on the particular recovery technique used, or within the lifetime of a given production well (overall recovery), or in some other manner as can be understood by those skilled in the art. For example, production performance may be improved by increasing the fluid drainage rate, or hydrocarbon drainage rate. Production performance may also be improved by reducing the residual hydrocarbon (or oil) saturation in a region in the reservoir after the hydrocarbon recovery process has been completed.

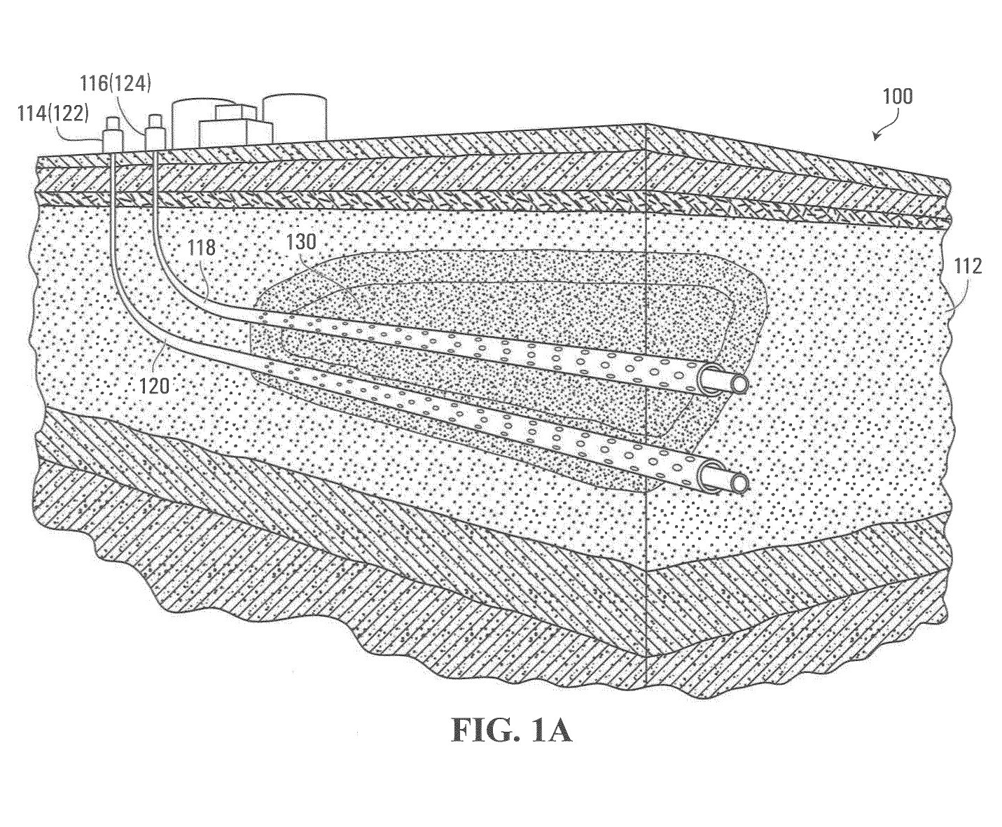

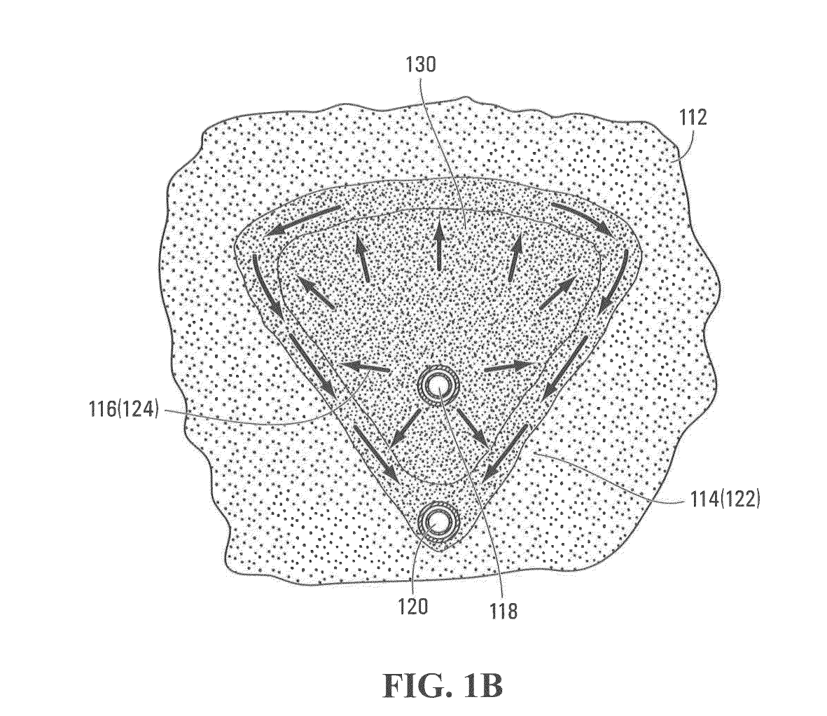

FIG. 1A schematically illustrates an example of a Steam-Assisted Gravity Drainage (SAGD) arrangement 100 in a reservoir 112 of bituminous sands, according to an embodiment of the invention. SAGD arrangement 100 includes a pair of wells, injection well 118 and production well 120. Surface facilities (not shown) are provided to inject steam and vapour of selected surfactants in injection well 118, and to produce fluids from production well 120. Injection well 118 is completed with a perforated or slotted liner along the horizontal section of the well for injecting the steam and surfactant vapour into a region of reservoir 112. Production well 120 is completed with a slotted liner along the horizontal section of the well for collecting fluid drained from reservoir 112 by gravity.

During use, according to an embodiment of the invention, steam is injected into reservoir 112 through injection well 118. The injected steam heats up the reservoir formation and softens the bitumen in the injected region in the reservoir 112. As heat is transferred to the bituminous sands, steam condenses and a fluid mixture containing condensed steam and softened bitumen forms. The fluid mixture drains downward due to gravity, and a porous region 130, referred to as the “steam chamber,” is created in reservoir 112. This process is schematically illustrated in FIG. 1B. The fluid mixture generally drains downward along the edge of steam chamber 130 towards the production well 120. Condensed steam (water) and hydrocarbons in the fluid mixture collected in the production well 120 are then produced (transferred to the surface), such as by gas lifting or through pumping as is known to those skilled in the art.

If no surfactant is used, in a typical SAGD process, the fluid mixture includes a stream of condensed steam (water, referred to as the water stream herein) which flows at a faster rate (referred to as the water flow rate herein), and a stream of softened bitumen containing hydrocarbons (referred to as the oil stream herein) which flows at a slower rate (referred to as the oil flow rate herein). It has been recognized that when vapour of a suitable surfactant is delivered to steam chamber 130 and then condensed and dispersed in the steam chamber 130 such as in the fluid mixture, oil production performance, such as one or more of oil production rate, cumulative steam-to-oil ratio (CSOR), and overall efficiency, can be improved.

In this regard, it is recognized that the production performance can be increased through a number of different mechanisms.

Consequently, a number of factors may be considered when selecting surfactants suitable for use in a SAGD process. One factor is whether the surfactant can increase the mobility of a hydrocarbon (or oil) in the region. The term “mobility” is used herein in a broad sense to refer to the ability of a substance to move about, and is not limited to the flow rate or permeability of the substance in the reservoir. For example, the mobility of oil may be increased when the oil becomes easier to detach from the sand it is attached to, or when the oil has become mobile, even if its viscosity or flow rate remains the same. The mobility of oil may also be increased when its viscosity is decreased, or when its effective permeability through the bituminous sands is increased.

Another factor is whether the surfactant can significantly reduce the IFT between oil and water or between oil and sand or other solid materials. A further factor is whether the surfactant can serve as a wetting agent to increase the flow rate of oil or the fluid mixture. An additional factor is whether the surfactant can act as an emulsifier for forming an oil-in-water emulsion, either alone or in combination with another additive such as a solvent.

In selected embodiments of the invention, one type of surfactants, such as a surfactant selected from alcohol ethoxylates, alkylphenol ethoxylates, or tertiary acetylenic diols including tertiary acetylenic diol ethoxylates, may be sufficient to improve production performance. In other selected embodiments of the invention, another type of surfactants, such as amino alcohols including monoethanolamine (MEA), diethanolamine (DEA), or triethanolamine (TEA) may also be sufficient to improve production performance.

In other embodiments of the invention, a surfactant may be used in combination with another surfactant or a solvent to provide improved production performance. The solvent may include one, or a combination, of alkanes, benzenes, toluenes, diesels, suitable C₃-C₁₅ hydrocarbons, or the like.

For instance, in selected embodiments of the invention, two types of non-ionic surfactants can be used, both of which may be selected to improve the rate of hydrocarbon recovery and overall hydrocarbon recovery.

A first type of surfactant is water soluble, or has a relatively high HLB, such as greater than 7. In some embodiments of the invention, the first type of surfactant may have an HLB greater than 8, such as greater than 9. The first type of surfactant may function at a relatively low vapour pressure, reduce IFT between different adjacent materials, and improve oil-water relative permeability. Many examples of the first type of surfactant are soluble in water with an HLB greater than 9.

Without being limited to any particular theory, it is expected that the first type of surfactant, when delivered as a vapour into the reservoir, such as into the steam chamber 130, acts primarily in the core of the steam chamber due to its water solubility (and possibly relatively low vapour pressure), and can be expected to reduce residual oil saturation. When the oil content in the reservoir is low, such as when the oil content in the drainage fluid is lower than 30% by volume, the dispersion of the first type of surfactant may facilitate the formation of an oil-in-water emulsion under suitable conditions. An oil-in-water emulsion is expected to have a lower viscosity that approaches the viscosity of water, as compared to the viscosity of oil or a water-in-oil emulsion. However, it is expected that in many reservoirs suitable for oil recovery, reservoir conditions dictate that the oil content in the drainage fluid is about 35-70% by volume, and in such conditions a reverse emulsion (water-in-oil) is more likely to form than an oil-in-water emulsion.

Examples of the first type of surfactant include, but are not limited to, alcohol ethoxylates such as TERGITOL™ 15-S-9 (T-15-S-9), CARBOWET™ 76 (C-76), NOVELFROTH™ (E-190) and NOVELFROTH™ 234 (E-234), and alkylphenol ethoxylates such as TRITON™ X-100 (TX-100), or the like. E-190 and E-234 have a higher vapour pressure as compared to longer chain alcohol ethoxylates, and when delivered as a vapour into the steam chamber, they may be expected to condense at somewhere between the core and the edge of the steam chamber. Tertiary acetylenic diol ethoxylates may also be suitable for use as the first type of surfactant in some embodiments of the invention.

A second type of surfactant is water insoluble, or has an HLB less than 8. The second type of surfactant typically has a vapour pressure that is more comparable with the vapour pressure of steam. This second type of surfactant is expected to be less effective at reducing IFT as compared to the first type of surfactant. The second type of surfactant may be soluble in oil and may have an HLB less than 5.5.

Without being limited to any particular theory, it is expected that the second type of surfactant may act primarily at the edge of the steam chamber, and may increase oil recovery by promoting additional drainage of oil from the periphery of the steam chamber to the production well. Examples of this second type of surfactant include, but are not limited to, tertiary acetylenic diols, such as SURFYNOL™ 82 (S-82) and SURFYNOL™ 104PA (S-104PA).

Either of the two types of surfactant can be injected into the steam chamber with a solvent to improve the rate of hydrocarbon recovery. If reservoir conditions produce a water-in-oil emulsion (with a 35-70% oil content by volume), then the injection of a small amount of a suitable solvent, such as a solvent with at least 3 carbons (e.g., hexanes or an alkane with a longer alkyl chain), into the steam chamber could possibly result in the emulsion viscosity being reduced to close to that of the viscosity of the oil in the reservoir. Lowering the emulsion viscosity allows more oil to be produced, or the mobile oil can be produced faster.

In some embodiments of the invention, the two types of surfactants may be used separately or independently. However, a combination of both types of surfactants may provide improved oil production performance as compared to using no surfactant or only one type of surfactant. Without being limited to any specific theory, it is expected that most oil drains to the production well from the edge of the steam chamber, but some oil may drain from the center (core) portion of the steam chamber. With both types of surfactants being injected into the steam chamber, the first type of surfactant can condense and act primarily in the core region and the second type of surfactant can condense and act primarily along the edge of the steam chamber. This thus may allow further reduction of the residual oil saturation (by obtaining additional oil from different areas of the steam chamber), and also acceleration of the oil production rate, depending on the particular surfactants used.

As noted above, a possible mechanism to improve hydrocarbon production is the reduction of IFT between oil and one or more of its surrounding materials including water and sand (or other solid objects present in the formation). The reduction of IFT between oil and water can promote the formation of an oil-in-water emulsion. The reduction of IFT between oil and sand and/or reduction of IFT between oil and water can also reduce the capillary resistance of sand to oil flow and can thus increase the oil flow rate. Thus, suitable surfactants may include suitable wetting agents or other surfactants that can reduce IFT between oil and water, or between oil and sand (or other solid materials in the formation). Reduction of IFT may also have the effect of increasing the amount of removable bitumen for a given reservoir formation. That is, the residual bitumen saturation in the formation (Sₒᵣ) may be reduced as compared to oil production without surfactant after the same period of production at the same cumulative water/steam injection. The reduced Sₒᵣ will result in higher recovery as well as faster drainage.

One possible effect of a suitable surfactant is that it can facilitate and promote the formation of an oil-in-water emulsion. Without being limited to any particular theory, it is expected that the hydrocarbons in an oil-in-water emulsion can be transferred to the production well 120 at a faster rate because the flow rate of the oil-in-water emulsion is expected to be faster than that of an oil stream that flows at a separate speed from the water stream in the fluid mixture. In other words, when oil droplets are dispersed in and carried by a water stream, the fluid mixture flows at a rate that is close to the water flow rate. By comparison, if the fluid mixture is a water-in-oil emulsion, the fluid mixture would flow at a slower rate than the oil flow rate. Thus, the formation of an oil-in-water emulsion can increase the drainage rate of hydrocarbons to production well 120. Conveniently, it also requires less steam (water) to produce the same amount of oil. Thus, emulsifiers that can facilitate and promote the formation of an oil-in-water emulsion may be suitable surfactants in embodiments of the present invention.

The surfactant should also be suitable for use under SAGD operating conditions, which include certain temperatures, pressures and chemical environments. For example, the surfactants should be chemically stable under SAGD conditions. The surfactants may also be non-ionic and able to vapourize to obtain the desired vapour pressure under SAGD conditions.

Without being limited to any specific theory, it is expected that in some embodiments of the invention, delivering the surfactant into the steam chamber in the vapour form may be more efficient and more effective than delivering the surfactant in the liquid form or using a surfactant dissolved in the steam. Vapour delivery is expected to provide better dispersion and integration of the surfactant in the region or in the fluid mixture in some embodiments of the invention depending on the particular application.

In a SAGD scheme, in order for an injected substance to travel beyond the well bore vicinity, it may need to be in vapour form for it to be carried with the injected steam. Only then can it interact with the vapour-liquid interface where the bulk of the oil drainage occurs.

In selected embodiments of the invention, a suitable surfactant may be an alcohol ethoxylate or an amino alcohol, which conveniently has various desired properties, including those discussed above (also see Examples below). Other surfactants may also be used and some examples thereof will be discussed below and in the Examples.

The surfactant vapour may be delivered into steam chamber 130 using any suitable delivery mechanism or route. For example, injection well 118 may be conveniently used to deliver the surfactant vapour.

Thus, in an exemplary embodiment of the invention as illustrated in FIGS. 1A and 1B, vapour of a surfactant 124 at a sufficient vapour pressure is co-injected with steam 116 into steam chamber 130 through injection well 118. The injected steam 116 softens the bitumen in reservoir 112. In various embodiments of the invention, softening the bitumen may further involve injecting a solvent (not shown) into the region to reduce the viscosity of the bitumen. As a result, a fluid 114 comprising hydrocarbons 122, condensed steam (water) and condensed surfactant is formed in steam chamber 130. Fluid 114 is drained by gravity along the edge of steam chamber 130 into production well 120 for recovery of hydrocarbons 122. As discussed above, in various embodiments of the invention, the surfactant 124 is selected so that dispersion of the surfactant 124 in the steam chamber 130, as well as in the interface fluid 114 increases the flow rate of hydrocarbons 122 in the fluid 114 from steam chamber 130 to the production well 120. The surfactant 124 condenses in the steam chamber 130 and is dispersed in the fluid 114 so as to increase the rate of drainage of hydrocarbons 122 from the reservoir 112 into the production well 120.

Various embodiments of the invention disclosed herein may be employed in in situ thermal recovery processes, such as Steam-Assisted Gravity Drainage (SAGD) operations, Cyclic Steam Stimulation (CSS), Steam flood, or a Solvent-Aided Process (SAP). Selected embodiments of the invention disclosed herein may be applicable to existing SAGD developments, such as after the oil production rate in such a development has peaked.

In various embodiments of the invention, the term “reservoir” refers to a subterranean or underground formation comprising recoverable hydrocarbons; and the term “reservoir of bituminous sands” refers to such a formation wherein at least some of the hydrocarbons are viscous and immobile and are disposed between or attached to sands. In various embodiments of the invention, the terms “hydrocarbons” or “hydrocarbon” relate to mixtures of varying compositions comprising hydrocarbons in the gaseous, liquid or solid states, which may be in combination with other fluids (liquids and gases) that are not hydrocarbons. For example, “heavy oil”, “extra heavy oil”, and “bitumen” refer to hydrocarbons occurring in semi-solid or solid form and having a viscosity in the range of about 1000 to over 1,000,000 centipoise (mPa·s) measured at original in situ reservoir temperature. In this specification, the terms “hydrocarbons”, “heavy oil”, “oil” and “bitumen” are used interchangeably. Depending on the in situ density and viscosity of the hydrocarbons, the hydrocarbons may comprise, for example, a combination of heavy oil, extra heavy oil and bitumen. Heavy crude oil, for example, may be defined as any liquid petroleum hydrocarbon having an American Petroleum Institute (API) Gravity of less than about 20° and a viscosity greater than 1000 mPa·s. Oil may be defined, for example, as hydrocarbons mobile at typical reservoir conditions. Extra heavy oil, for example, may be defined as having a viscosity of over 10,000 mPa·s and about 10° API Gravity. The API Gravity of bitumen ranges from about 12° to about 7° and the viscosity is greater than about 1,000,000 mPa·s. Bitumen is generally non-mobile at typical native reservoir conditions.

The hydrocarbons in the reservoir of bituminous sands occur in a complex mixture comprising interactions between sand particles, fines (e.g., clay), and water (e.g., interstitial water) which form complex emulsions during processing. The hydrocarbons derived from bituminous sands may contain other contaminant inorganic, organic or organometallic species which may be dissolved, dispersed or bound within suspended solid or liquid material. Accordingly, separation of hydrocarbons from the bituminous sands in situ remains challenging. Use of a surfactant vapour according to various embodiments of the invention to recover hydrocarbons in a reservoir of bituminous sands may conveniently provide one or more benefits, as compared to a conventional SAGD recovery process. The dispersion of the surfactant in the steam chamber may provide one or more of the following effects: reducing IFT between hydrocarbons and water; reducing IFT between hydrocarbons and sand (reservoir rock wettability) or other solid materials in the formation; reducing flowing fluid viscosity; or formation of a breakable emulsion comprising water and discrete regions of hydrocarbons in water, which in turn may have the effect of increasing the drainage rate of the hydrocarbons from the steam chamber to the production well. More oil in the reservoir may become removable after dispersion of the surfactant. As a result, enhanced recovery rate or performance may be achieved. In application to SAGD, the surfactant injected into the reservoir (steam chamber) as vapour can condense at the edges of the steam chamber due to the decrease in temperature at the edges and the condensed surfactant can begin to mix into the draining fluid formed of oil and water (condensed steam).

In a SAGD operation, the steam temperature in the injection well and the temperature in the steam chamber may range from about 158.8° C. to about 310° C. According to various embodiments of the invention, the surfactant may be selected such that it is chemically stable at such temperatures and therefore remains effective after being injected into the steam chamber. For example, the reservoir of bituminous sands undergoing SAGD may have a temperature in the range from about 158.8° C. to 310° C. and a pressure in the range from about 600 kPa to about 9900 kPa depending on the stage of processing.

In various embodiments of the invention, the term “surfactant” refers to a compound that reduces IFT between two liquids or a liquid and a solid (e.g., a hydrocarbon and water or a hydrocarbon, sand and water in bituminous sands). In various embodiments of the invention, a suitable surfactant for use has the following additional characteristics: vapourization and chemical stability at reservoir conditions used in thermal hydrocarbon recovery (e.g., temperatures and pressures that are typical at various stages of SAGD); low critical micelle concentration (CMC) for better project economics; enhancement of water-wetness of the reservoir rock; reduction in residual oil saturation (Sₒᵣ) and/or improvement of the oil relative permeability, with optional reduction of viscosity of hydrocarbon flow; compatibility with formation water; reduction of hydrocarbon-water or hydrocarbon-sand IFT at reservoir conditions used in thermal recovery, optionally causing formation of an oil-in-water emulsion or avoiding the formation of a reverse water-in-oil emulsion at the edges of the steam chamber (e.g., having a suitable HLB greater than about 9 for surfactants that act as emulsifiers) and wherein the emulsion has suitable characteristics including easy downstream processing (e.g., demulsification); or a combination of characteristics thereof. For clarification, as used herein, surfactants include an alcohol ethoxylate, a phenol ethoxylate, a tertiary acetylenic diol, an alkylmercaptan ethoxylate, an alkylpropoxy ethoxylate, an amine ethoxylate, an amide ethoxylate, an amino alcohol, or an alcoholamide.

In various embodiments of the invention, the term “surfactant” further includes a surfactant precursor which under selected conditions may form another surfactant in situ. For example, a mix of two or more surfactants may produce a more optimal HLB for the given process.

In various embodiments of the invention, the surfactant may be a compound represented by the chemical formula of

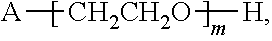

wherein (i) m is 1, and A is —NH₂ or —N(H)CH₂CH₂OH; or (ii) m is 1 or greater than 1, and A is —OR₁, R₁ being an alkyl group.

In various embodiments of the invention, the non-ionic surfactant may be an alcohol ethoxylate, a phenol ethoxylate, a tertiary acetylenic diol, an alkylmercaptan ethoxylate, or an alkylpropoxy ethoxylate.

The alcohol ethoxylate may be a primary, secondary, or tertiary alcohol ethoxylate. In various embodiments of the invention, the alcohol ethoxylate may have the chemical formula of

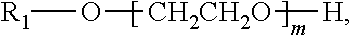

wherein R₁ is a linear or branched alkyl group having more than 5 carbon atoms, and m is greater than 1. The alcohol ethoxylate may also have the chemical formula of

C₁₂₋₁₄H₂₅₋₂₉O[CH₂CH₂O]₉H;

C₁₂₋₁₅H₂₅₋₃₁O[CH₂CH₂O]_{2.8}H;

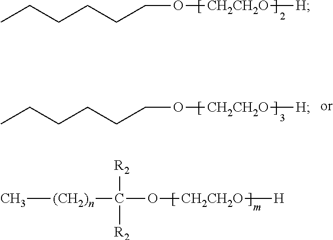

wherein m is 2 or 3, n is 2 or 3, and R₂ is methyl or ethyl.

Possible alcohol ethoxylates may also have the chemical formula of

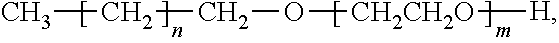

wherein n is greater than 3 and m is greater than 1.

In various embodiments of the invention, the phenol ethoxylate may have the chemical formula of

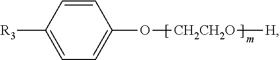

wherein R₃ is hydrogen, or a linear or branched alkyl group, and m is greater than 1. R₃ may be a linear or branched alkyl group having more than 2 carbon atoms.

The phenol ethoxylate may comprise an alkylphenol ethoxylate. The alkylphenol ethoxylate may have the chemical formula of

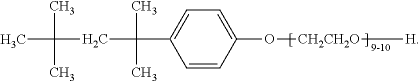

Other possible alkylphenol ethoxylates may have the chemical formula of

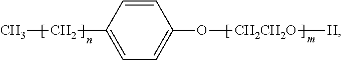

wherein m is greater than 1, and n is greater than 1.

Other possible phenol ethoxylates may have the chemical formula of

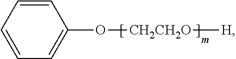

wherein m is greater than or equal to 1.

In various embodiments of the invention, the tertiary acetylenic diol may have the chemical formula of

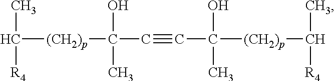

wherein R₄ is hydrogen or methyl, and p is 1 or 2.

The tertiary acetylenic diol may also have the chemical formula of

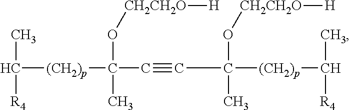

wherein R₄ is hydrogen or methyl, and p is 1-3.

The tertiary acetylenic diol may also have the chemical formula of

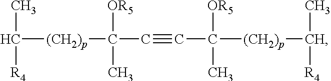

wherein R₄ is hydrogen or methyl, R₅ is hydrogen or hydroxyethyl, and p is 1-3 when R₅ is hydroxyethyl, or is less than 3 when R₅ is hydrogen.

In various embodiments of the invention, the alkylmercaptan ethoxylate may have the chemical formula of

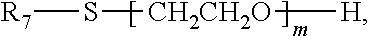

wherein R₇ is a linear or branched C₆-C₁₀ alkyl group, and m is 2-4.

In various embodiments of the invention, the alkylpropoxy ethoxylate may have the chemical formula of

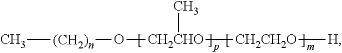

wherein m is 2 or 3, n is 3 or 4 and p is 1 or 2.

Other non-ionic surfactants may be acetylenic diol ethoxylates having the formula

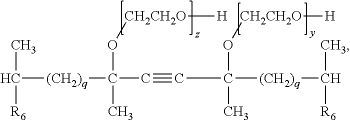

wherein R₆ is hydrogen, or a linear or branched alkyl group, q is greater than 1, and at least one of y and z is greater than or equal to 1, or a combination thereof.

In various embodiments of the invention, the surfactant may be an amine ethoxyate, an amide ethoxylate, an amino alcohol, or an alcoholamide.

In various embodiments of the invention, a suitable amino alcohol may be an ethanolamine such as MEA, DEA or TEA. The test results in the Examples show that MEA or DEA can provide improved performance over some other amine containing compounds such as ammonia. From these results, it can be expected that other amino alcohols having similar chemical structures, such as TEA, will also be suitable surfactants in some applications.

Some commercially available surfactants and their main chemical components are listed below.

T-15-S-9 contains a C₁₂-C₁₄ secondary alcohol ethoxylate with nine [CH₂CH₂O—] groups, with the chemical formula of C₁₂₋₁₄H₂₅₋₂₉O[CH₂CH₂O]—H.

TX-100 contains is a tertiary alkylphenol ethoxylate with 9-10 [—CH₂CH₂O—] groups), with the chemical formula of

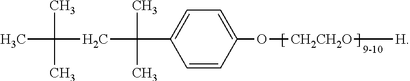

S-82 contains a tertiary acetylenic diol with the chemical formula of

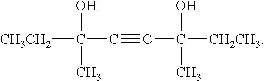

S-104PA contains a tertiary acetylenic diol with the chemical formula of,

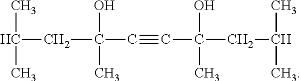 [SMILES: CC(C)CC(C)(O)C#CC(C)(O)CC(C)C]

C-76 contains a C₁₂-C₁₅ alcohol ethoxylate with 2.8 [—CH₂CH₂O—] groups, with the chemical formula of C₁₂₋₁₅H₂₅₋₃₁O[CH₂CH₂O]_{2.8}H.

E-190 contains a C₆ alcohol ethoxylate with 2 [—CH₂CH₂O—] groups, with the chemical formula of

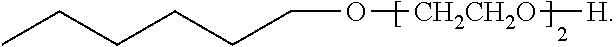

E-234 contains a C₆ alcohol ethoxylate with 3 [—CH₂CH₂O—] groups, with the chemical formula of

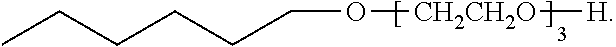

ALFONIC™ 1012-5 (A-1012-5) has the chemical formula of

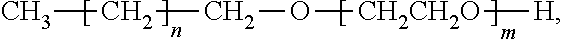

wherein n is 8-10 and m is 5.

Certain properties of selected surfactants are shown in Table 1.

TABLE 1

| Surfactant | MW (g/mol) | CMC (ppm) | HLB |
|---|---|---|---|
| TRITON ™ X-100 (TX-100) | 624 | 189 | 13.6 |
| TERGITOL ™ 15-S-9 (T-15-S-9) | 596 | 52 | 13.3 |
| NOVELFROTH ™ 190 (E-190) | 228 | — | 11.0 |
| NOVELFROTH ™ 234 (E-234) | 291 | — | 12.7 |
| CARBOWET ™ 76 (C-76) | — | — | 7.5 |
| SURFYNOL ™ 82 (S-82) | 169 | — | 5.0 |
| SURFYNOL ™ 104PA (S-104PA) | 226 | — | 4.0 |
| ALFONIC ™ 1012-5 (A-1012-5) | 410 | — | 12 |

In various embodiments of the invention, the surfactant may be delivered to the reservoir of bituminous sands in a number of ways. For example, in selected embodiments of the invention, the surfactant or a combination of surfactants may be injected into the region from which hydrocarbons are to be recovered (e.g., the steam chamber) as vapour separate from steam or as vapour co-injected with steam. The surfactant may be injected as a mixture of steam and surfactant (e.g., mixed ex situ) or as separate streams for mixing in situ. The surfactant or mixture of surfactants maybe utilized in combination with other processes such as a Solvent-Aided Process (SAP) or a similar process in which small amounts of chemicals or solvents such as light hydrocarbons are utilized to further reduce the oil viscosity. One reason for the addition of small amounts of solvent is to counterbalance the slight viscosity increase on account of formation of a water-in-oil emulsion that occurs with some surfactants. In various embodiments of the invention, the surfactant may be injected in liquid form or preferably in vapour form. In various other embodiments of the invention, the surfactant may be delivered to the edge of the steam chamber. In various embodiments of the invention, the water (condensed steam) and the oil have independent flows at the steam chamber edge. The water flow is generally much faster than the oil flow. The characteristics of the surfactant alone or in combination with the method of delivery are such that modulation of the flow rates of water (condensed steam) and oil can be achieved. Namely, the surfactant facilitates decreasing the water flow and increasing the oil flow, which in turn increases the production rate. In various embodiments of the invention, decreasing the water flow and increasing the oil flow using the surfactant is achieved by forming an emulsion comprising water and discrete regions of oil in water.

In various embodiments of the invention, the injection of surfactant may comprise an injection pattern. For example, the injection pattern may comprise simultaneous injection with the steam or staged (e.g., sequential) injection at selected time intervals and at selected locations within the SAGD operation (e.g., SAGD well pad). The injection may be performed in various regions of the well pad or well pads to create a target injection pattern to achieve target results at a particular location of the pad. In various embodiments of the invention, the injection may be continuous or periodic. The injection may be performed through an injection well (e.g., injection well 118), which in selected embodiments of the invention, may involve injection at various intervals along a length of the well. In various other embodiments of the invention, the steam may be injected from one injection well and the surfactant may be injected from another injection location (e.g., through a surfactant delivery conduit). For example, in various embodiments of the invention, the injection may involve top loading of the surfactant from another injection location. In various embodiments of the invention, one or more of the former steam injectors may be converted into a surfactant injector(s), or new surfactant injectors may be created. For example, a surfactant may be injected from a nearby well drilled using Wedge Well™ technology or through a new well that can be drilled at the top of a SAGD zone. The surfactant may also be injected through a gas cap which lies above the SAGD zone. Another possibility is to inject the surfactant through a vertical well located in the vicinity of steam chamber. In various embodiments of the invention, the surfactant may be injected at various stages of a thermal in situ recovery process such as SAGD. In various embodiments of the invention, the injection of a particular surfactant (e.g., having a particular stability, vapourization, etc.) may be tailored to the particular temperature of the reservoir or a reservoir portion into which the surfactant is to be injected. In various embodiments of the invention, the surfactant may be injected as an aerosol or spray.

A concentration of the surfactant effective at enhancing hydrocarbon recovery can vary depending on the selection of processing conditions (e.g., injection rate and manner, temperature and pressure of the steam, surfactant type and properties at reservoir conditions, reservoir properties such as permeability, or a combination thereof). In various embodiments of the invention, the surfactant may have a concentration from about 10 ppm to about 10,000 ppm, measured at room temperature based on the liquid volumes of the surfactant and steam (water). In some embodiments of the invention, the surfactant concentrations may be from about 10 ppm to about 8,000 ppm, such as from about 10 ppm to about 2000 ppm.

In various embodiments of the invention, a suitable concentration of the surfactant may be defined as that sufficient to produce a reduction in IFT of oil and water. In various embodiments of the invention, a suitable concentration of the surfactants may be further defined as that sufficient to reduce viscosity of the oil.

In various embodiments of the invention, a suitable surfactant is one which vapourizes at the temperature and pressure of the injection steam in the injection well.

In selected embodiments of the invention, when an emulsifier is used as the surfactant an emulsion of oil and water may form in the reservoir. In various embodiments of the invention, the emulsion is an oil-in-water emulsion, which comprises a hydrocarbon phase dispersed as droplets in water (condensed steam). Emulsions are thermodynamically unstable due to excess free energy associated with the surface of the dispersed droplets such that the particles tend to flocculate (clumping together of dispersed droplets or particles) and subsequently coalesce (fusing together of agglomerates into a larger drop or droplets) to decrease the surface energy. If these droplets fuse, the emulsion will “break” (i.e., the phases will separate) destroying the emulsion and making it difficult to, e.g., transport the resultant product for further processing. In various embodiments of the invention, the surfactant according to the process of the present invention prevents or slows down “breaking” of an emulsion in situ while allowing effective demulsification in downstream processing.

After the emulsion is removed from the reservoir, the emulsion may be further processed including demulsification using any conventional method to isolate the hydrocarbons. In various embodiments of the invention, partial demulsification or other processing may also occur at a selected stage in the in situ process.

Selected embodiments of the invention relate to a process of increasing recovery rate of hydrocarbon from a reservoir of bituminous sands. Bitumen in a region in the reservoir is softened to generate a fluid comprising a hydrocarbon, to allow the fluid to drain by gravity from the region into a production well below the region for recovery of the hydrocarbon. Vapour of an alcohol ethoxylate is provided to the region, and allowed to disperse and condense in the region. The vapour of the alcohol ethoxylate may be provided to the region at a partial pressure of about 85 kPa to about 590 kPa and a temperature from about 225° C. to about 275° C. The vapour of the alcohol ethoxylate may be provided to the region with steam from an injection well. The steam may be at a temperature from about 160° C. to about 310° C. and at a pressure of about 600 kPa to 10 MPa in the injection well. The steam may be at a temperature from about 225° C. to about 275° C. in the injection well. The molar ratio of the vapour of the alcohol ethoxylate to the steam in the injection well may be about 0.03:1 to about 0.1:1. The volume ratio of the alcohol ethoxylate to the steam, measured at room temperature on a liquid basis, may be about 10 ppm to about 2000 ppm, or may be about 10 ppm to about 8000 ppm when the alcohol ethoxylate is a secondary alcohol ethoxylate. A solvent may be provided to the region, wherein the solvent may include an alkane having at least 3 carbons and the weight ratio of the solvent to the steam is less than 1%. A tertiary acetylenic diol may also be provided to the region with the alcohol ethoxylate.

Selected embodiments of the invention also relate to a mixture for injection into a reservoir of bituminous sands to recover hydrocarbon from the reservoir. The mixture comprises steam at a temperature from about 160° C. to about 310° C. and a pressure of about 600 kPa to 10 MPa, and vapour of an alcohol ethoxylate. The steam in the mixture may be at a temperature from about 225° C. to about 275° C. and the vapour of the alcohol ethoxylate may have a partial pressure of about 85 kPa to about 590 kPa. The steam may be at a temperature from about 225° C. to about 275° C., and the volume ratio of the alcohol ethoxylate to the steam, measured at room temperature on a liquid basis, may be about 10 ppm to about 2000 ppm, or may be about 10 ppm to about 8000 ppm when the alcohol ethoxylate is a secondary alcohol ethoxylate. The mixture may also include a solvent. The solvent may be an alkane having at least 3 carbons and the weight ratio of the solvent to the steam is less than 1%. The mixture may further include a tertiary acetylenic diol.

Further selected embodiments of the invention relate to a system for recovery of hydrocarbon from a reservoir of bituminous sands. The system includes an injection well disposed in the reservoir for injecting steam into a region of the reservoir to soften bitumen in the region and generate a fluid comprising a hydrocarbon; a production well disposed in the reservoir below the injection well for receiving the fluid to recover the hydrocarbon; and a conduit in fluid communication with the reservoir. The conduit contains vapour of an alcohol ethoxylate for injection into the region. The conduit may be provided in the injection well.

Selected embodiments of the invention also relate to a process for recovery of hydrocarbon from a reservoir of bituminous sands. In this process, bitumen is softened in a region in the reservoir to generate a fluid comprising a hydrocarbon. The fluid is mobile to drain by gravity from the region into a production well below the region. The bitumen in the region is contacted with a first surfactant and a second surfactant to increase mobility of the hydrocarbon in the region. The first surfactant is water soluble and the second surfactant is water insoluble. Alternatively, the first surfactant has an HLB of greater than 8, and the second surfactant has an HLB less than 8. Hydrocarbons are produced from the fluid drained into the production well. The surfactants may be non-ionic. Vapour of the surfactants may be provided to the region at a temperature from about 225° C. to about 275° C. The HLB of the first surfactant may be greater than 9. The HLB of the second surfactant may be less than 5.5. The first surfactant may include an alcohol ethoxylate or a phenol ethoxylate, such as an alkylphenol ethoxylate. The second surfactant may include a tertiary acetylenic diol. A solvent may be provided to the region. The solvent may be an alkane having at least 3 carbons. The weight ratio of the injected solvent to the injected steam may be less than 1%.

Selected embodiments of the invention relate to a mixture for the above process, which includes steam at a temperature from about 160° C. to about 310° C. and a pressure of about 600 kPa to 10 MPa; the first surfactant; and the second surfactant. The mixture may further include the solvent with the weight ratio of the solvent to the steam being less than 1%.

Selected embodiments of the invention of the invention relate to another process for recovery of hydrocarbon from a reservoir of bituminous sands. In this process, steam is injected into a region in the reservoir to soften bitumen in the region and to generate a fluid comprising a hydrocarbon. The fluid is mobile to drain by gravity from the region into a production well below the region. The bitumen in the region is contacted with a surfactant and a solvent to increase mobility of the hydrocarbon in the region. The solvent has least 3 carbon atoms and the weight ratio of the solvent to the steam is less than 1%. Hydrocarbons are produced from the fluid drained into the production well. This process may be conveniently utilized when the weight ratio of hydrocarbons to water drained into the production well is less than 2. The solvent may include one or more alkanes having at least 6 carbons. The surfactant may be selected from alcohol ethoxylates, phenol ethoxylates such as alkylphenol ethoxylates, tertiary acetylenic diols, alkylmercaptan ethoxylates, alkylpropoxy ethoxylates, amine ethoxylates, amide ethoxylates, amino alcohols, alcoholamides, or the like. A combination of a surfactant of the first type and a surfactant of the second type as described herein may also be used.

Additional selected embodiments of the invention relate to a further process for recovery of hydrocarbon from a reservoir of bituminous sands. In this process, bitumen in a region in the reservoir is softened to generate a fluid comprising a hydrocarbon, to allow the fluid to drain by gravity from the region into a production well below the region for recovery of the hydrocarbon. Vapour of a non-ionic surfactant is provided to the region. The surfactant may be an alkylphenol ethoxylate having a partial pressure from about 60 kPa to about 150 kPa, or a tertiary acetylenic diol having a partial pressure from about 2400 kPa to about 6300 kPa. The alkylphenol ethoxylate may have a vapour phase partial pressure from about 60 kPa to about 145 kPa. The tertiary acetylenic diol may have a vapour phase partial pressure from about 2430 kPa to about 6260 kPa. The surfactant is condensed and dispersed in the region, so as to increase mobility of the hydrocarbon in the region. Hydrocarbons are produced from the fluid drained into the production well. The surfactant may be provided to the region with steam under a steam pressure from about 600 kPa to about 10 MPa at a temperature from about 160° C. to about 310° C. The temperature may be from about 225° C. to about 275° C.

In some embodiments of the invention, a mixture for injection into a reservoir of bituminous sands to recover hydrocarbon from the reservoir may include steam at a temperature from about 160° C. to about 310° C. and a pressure of about 600 kPa to 10 MPa; and vapour of the non-ionic surfactant described in the above paragraph. The mixture may be at a temperature from about 225° C. to about 275° C.

It should be understood that in any processes described here, bitumen in a region of the reservoir may be softened by injecting steam or a solvent into the region, or by heating the bitumen in the region.

Selected embodiments of the invention also relate to systems for recovery of hydrocarbon from a reservoir of bituminous sands. The system(s) may include an injection well disposed in the reservoir for injecting steam into a region of the reservoir to soften bitumen in the region and generate a fluid comprising a hydrocarbon, a production well disposed in the reservoir below the injection well for receiving the fluid to recover the hydrocarbon, and a conduit in fluid communication with the reservoir. In different embodiments of the invention, the conduit may contain vapour of a non-ionic surfactant as described above, or vapour of an amino alcohol such as MEA, DEA or TEA.

In some embodiments of the invention, surfactants that are in the liquid phase at surface conditions may be selected for easy handling.

In some embodiments of the invention, surfactants that can react with bitumen or oil, or an organic compound released from the bitumen or oil to reduce the total acid number (TAN) of the bitumen or oil may be selected.

Exemplary embodiments of the invention of the present invention are further illustrated with the following examples, which are not intended to be limiting.

### EXAMPLES

Experiments were conducted to determine the suitability of a surfactant for the processes described herein.

The materials used in the Examples were obtained as follows unless otherwise specified in the specific example.

Examples of the surfactants tested include phenol ethoxylates such as TRITON™ X-100 (TX-100), alcohol ethoxylates such as NOVELFROTH™ 190 (E-190), NOVELFROTH™ 234 (E-234), TERGITOL™ 15-S-9 (T-15-S-9), CARBOWET™ 76 (C-76), ALFONIC™ 1012-5 (A-1012-5), ammonia, amino alchohols such as MEA and DEA, tertiary acetylenic diols such as SURFYNOL™ 82 (S-82) and SURFYNOL™ 104PA (S-104PA).

In these examples, all references to surfactant concentrations (in ppm) refer to volume concentrations or ratios of the surfactant to steam on a liquid basis, as measured at room temperature, which was 22° C. unless otherwise specified.

### Example 1

### Interfacial Tension (IFT) Measurements

IFT of a surfactant at different concentrations in an oil-water mixture was measured using standard methods known to a skilled person. Specifically, a calibration curve of surfactant IFT at different surfactant concentrations was obtained by measuring the IFT of the surfactant in a mixture of a refined non-polar mineral oil of constant properties and distilled water. The calibration curve afforded determination of an effective amount of the surfactant in such an oil-water mixture based on a measured surfactant IFT.

IFT was measured using a Kruse IFT measurement device and following standard procedures.

Table 2 shows the IFT of TX-100 in the oil-water mixture (mineral oil) at various surfactant concentrations at about 20° C.

TABLE 2

| Concentration of TX-100 | IFT (Oil-Water) |
|---|---|
| (mg/L) | (mN/m) |
| 0 | 36.6 |
| 100 | 5.82 |
| 250 | 4.11 |
| 500 | 3.12 |
| 1000 | 2.68 |
| 2000 | 2.40 |

IFT measurements for E-234 and E-190 in the oil-water mixture at various surfactant concentrations at about 20° C. are shown in Table 3 and Table 4, respectively.

TABLE 3

| Concentration of E-234 | IFT (Oil-Water) |
|---|---|
| (mg/L) | (mN/m) |
| 0 | 36.9 |
| 50 | 31.7 |
| 100 | 27.5 |
| 500 | 19.2 |
| 1000 | 16.8 |
| 2000 | 14.5 |

TABLE 4

| Concentration of E-190 | IFT (Oil-Water) |
|---|---|
| (mg/L) | (mN/m) |
| 0 | 36.9 |
| 50 | 36.8 |
| 100 | 32.5 |
| 500 | 22.6 |
| 1000 | 19.8 |
| 2000 | 16.4 |

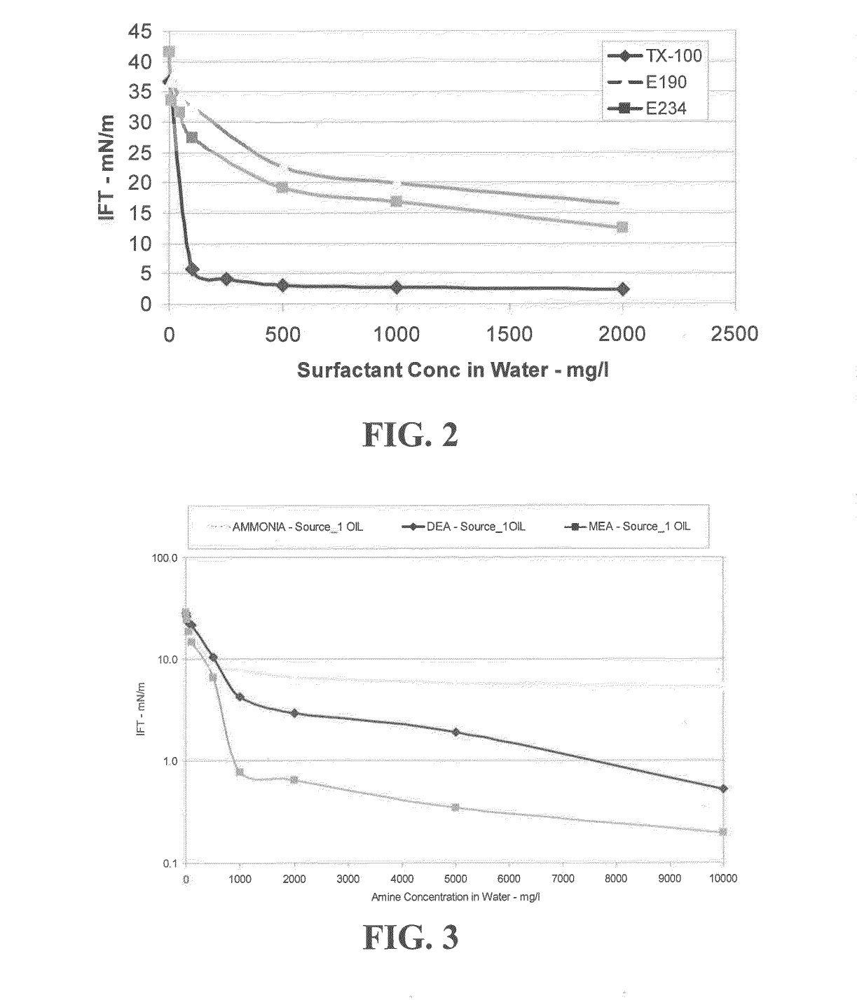

FIG. 2 illustrates IFT measurements for TX-100, E-190 and E-234 surfactants in the oil-water mixture (mineral oil).

The suitability of TX-100, E-190 and E-234 for treating hydrocarbons from two sources of bitumen (from different reservoirs, denoted source 1 and source 2) was evaluated based on the ability of each surfactant to reduce the IFT between each bitumen source and a mixture of water and surfactant. The experiments were conducted at about 60° C. and the IFT measurements are shown in Table 5 (source 1) and Table 6 (source 2).

TABLE 5

| Concentration of | IFT | IFT |
|---|---|---|
| Surfactant in Water | (Oil-Water) | (Oil-Water) |
| (mg/L) | E-190 (mN/m) | E-234 (mN/m) |
| 0 | 36.4 | 36.3 |
| 10 | 32.8 | 31 |
| 50 | 30.8 | 30.6 |
| 100 | 26.7 | 23.2 |
| 500 | 5.86 | 4.51 |
| 1000 | 2.15 | 1.52 |
| 2000 | 0.68 | 0.55 |
| 10000 | 0.45 | 0.43 |

TABLE 6

| Concentration of | IFT | IFT |
|---|---|---|
| Surfactant | (Oil-Water) | (Oil-Water) |
| in Water (mg/L) | E-190 (mN/m) | E-234 (mN/m) |
| 0 | 36.1 | 36.2 |
| 10 | 33.4 | 31.3 |
| 50 | 31.5 | 30.3 |
| 100 | 27.1 | 19.4 |
| 500 | 6.7 | 3.8 |
| 1000 | 2.98 | 1.32 |
| 2000 | 1.5 | 0.58 |
| 10000 | 0.43 | 0.32 |

As shown in Tables 5 and 6, E-190 and E-234 appeared to have relatively comparable IFT reduction effects.

Ammonia, MEA, DEA and T-15-S-9 were similarly evaluated for their abilities to reduce IFT between the hydrocarbon samples obtained from bitumen source 1 and a mixture of water and surfactant. These IFT measurements were conducted using various concentrations of each surfactant at about 60° C., with results shown in Table 7. IFT measurements from ammonia, MEA and DEA are shown also in FIG. 3.

TABLE 7

| | IFT | IFT | IFT | IFT |
|---|---|---|---|---|
| Concentration of | (Oil-Water) | (Oil-Water) | (Oil-Water) | (Oil-Water) |
| Surfactant | DEA | MEA | Ammonia | T-15-S-9 |
| in Water (mg/L) | (mN/m) | (mN/m) | (mN/m) | (mN/m) |
| 0 | 28.5 | 28.9 | 29.2 | 28.5 |
| 10 | 26.1 | 24.6 | 26.0 | 5.5 |
| 50 | 22.6 | 18.7 | 21.6 | 4.4 |
| 100 | 21.7 | 14.8 | 17.8 | 2.1 |
| 500 | 10.6 | 6.59 | 8.94 | 0.8 |
| 1000 | 4.26 | 0.78 | 7.79 | 0.50 |
| 2000 | 2.95 | 0.65 | 6.54 | 0.31 |
| 5000 | 1.90 | 0.35 | 5.77 | 0.13 |
| 10000 | 0.52 | 0.20 | 5.36 | 0.10 |

The results indicate that MEA, DEA and T-15-S-9 were effective at reducing oil-water IFT at the conditions studied, with oil-water IFT values at high surfactant concentrations being comparable to the relatively low values observed with E-190 and E-234 (see Tables 5 and 6). Ammonia was found to be less effective under the conditions studied. T-15-S-9 appeared to more effectively reduce IFT relative to ammonia, MEA and DEA, especially at low surfactant concentrations in the range of 10-500 ppm.

Surfactants TX-100, S-82, S-104PA and C-76 were similarly evaluated for their abilities to reduce IFT reduction between bitumen source 1 and a mixture of water and surfactant. These IFT measurements were conducted using various concentrations of each surfactant at room temperature, with results shown in Table 8.

TABLE 8

| Concentration | IFT | IFT | IFT | IFT |
|---|---|---|---|---|
| of Surfactant | (Oil-Water) | (Oil-Water) | (Oil-Water) | (Oil-Water) |
| in Water | TX-100 | S-82 | S-104PA | C-76 |
| (mg/L) | (mN/m) | (mN/m) | (mN/m) | (mN/m) |
| 0 | 28.3 | 28.30 | 28.30 | 28.30 |
| 50 | 1.79 | 2.60 | 2.94 | 2.05 |
| 100 | 0.40 | 2.11 | 2.82 | 1.61 |
| 500 | 0.31 | 1.85 | 2.62 | 0.71 |
| 1000 | 0.27 | 1.4 | 1.75 | 0.58 |
| 2000 | 0.24 | 1.13 | 1.40 | 0.43 |
| 10000 | N/A | 0.77 | 0.57 | N/A |
| 30000 | N/A | 0.55 | 0.39 | N/A |

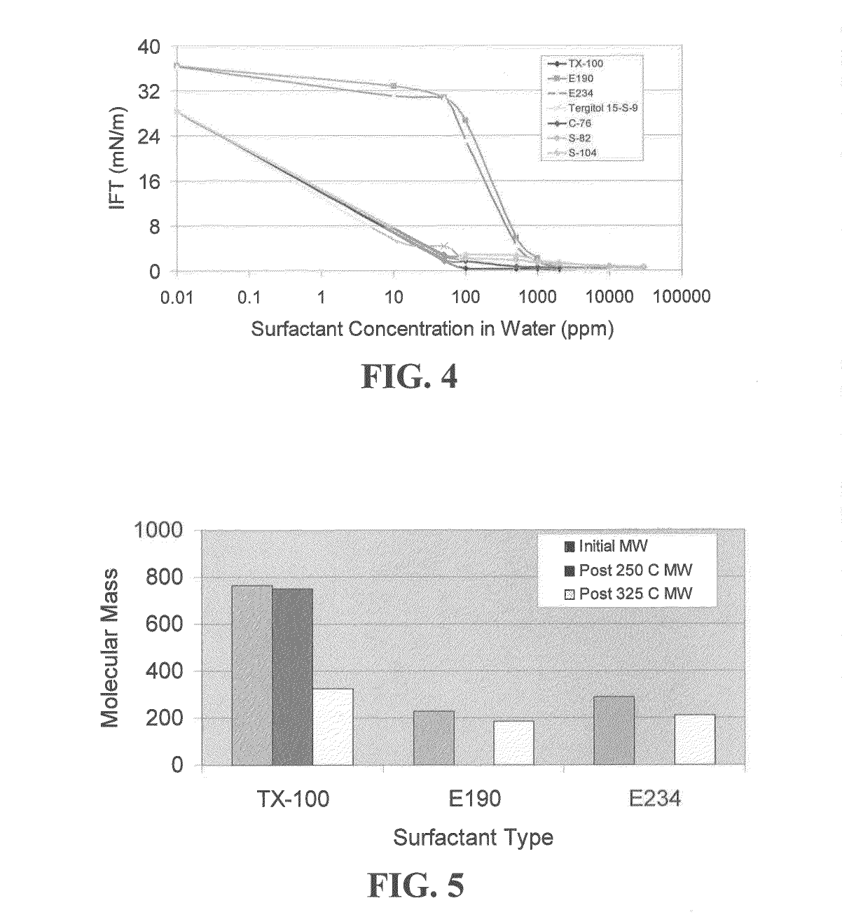

The hydrocarbon samples used for testing ammonia, MEA, DEA, T-15-S-9, TX-100, S-82, S-104PA and C-76 appeared to have a different baseline IFT (about 28-29 mN/m) compared to E-190 and E-234 (about 36 mN/m). This difference may relate to trace contamination or compositional changes between two batches of hydrocarbons sampled at different times from bitumen source 1. Combined results for TX-100, E-190, E-234, T-15-S-9, C-76, S-82 and S-104PA (bitumen source 1) are shown in FIG. 4.

Based on IFT reduction and volatility (see Example 4), the results obtained at the conditions discussed above suggest that at these conditions surfactants E-190 and E-234 are actually more suitable than TX-100.

It would be readily appreciated by a skilled person that a particular surfactant may be chosen for treating hydrocarbons from a particular source based on molecular compatibility in terms of carbon chain length and the composition of the hydrocarbon source. For example, the concentration of organic acids present in the hydrocarbon source may affect the performance of certain surfactants. Therefore, in order to determine the suitability of a surfactant for treating hydrocarbons from a particular source, standard laboratory tests may be performed as described in Examples 1 to 4.

### Example 2

### Thermal Stability of Surfactants

Thermal stability of neat TX-100 (i.e., no detectable amount of water), as measured by its MW, was studied under various combinations of temperature and pressure. The MW was measured using freezing point depression and standard analytical techniques known to a skilled person. Specifically, initial measurement of the MW of TX-100 was found to be about 764.1 g/mol. TX-100 was subsequently placed in an anaerobic environment at about 265° C. for 48 hours and the MW post heating was about 749.5 g/mol, indicating that TX-100 was thermally stable in an anaerobic environment at 265° C. for at least 48 hours.

The thermal stabilities of TX-100, E-190 and E-234 (all neat) in an anaerobic environment at other temperatures up to about 325° C. over 24 hours were similarly measured and the results are shown in Table 9 and FIG. 5.

TABLE 9

| | Initial MW | Post 250° C. | Post 325° C. |
|---|---|---|---|
| Surfactant | (g/mol) | MW (g/mol) | MW (g/mol) |
| TX-100 | 762.6 | 749.3 | 323.9 |
| E-190 | 227.8 | | 186.9 |
| E-234 | 290.9 | | 210.7 |

These results suggest that in an anaerobic environment at 325° C., all three surfactants could undergo partial thermal decomposition. Given the degree of decomposition at this temperature, the surfactants would not likely be suitable for extremely high temperature operations. Accordingly, suitable surfactants such as TX-100, E-190 and E-234 may be used with an acceptable degree of decomposition in various embodiments of the invention at a temperature ranging from about 180° C. to about 290° C. In selected embodiments of the invention, the surfactants may be used in operations where the temperature is from about 180° C. up to about 275° C. Suitability of other surfactants at various temperatures may be readily determined using the process described herein.

### Example 3

### Vapour Pressures of Surfactants

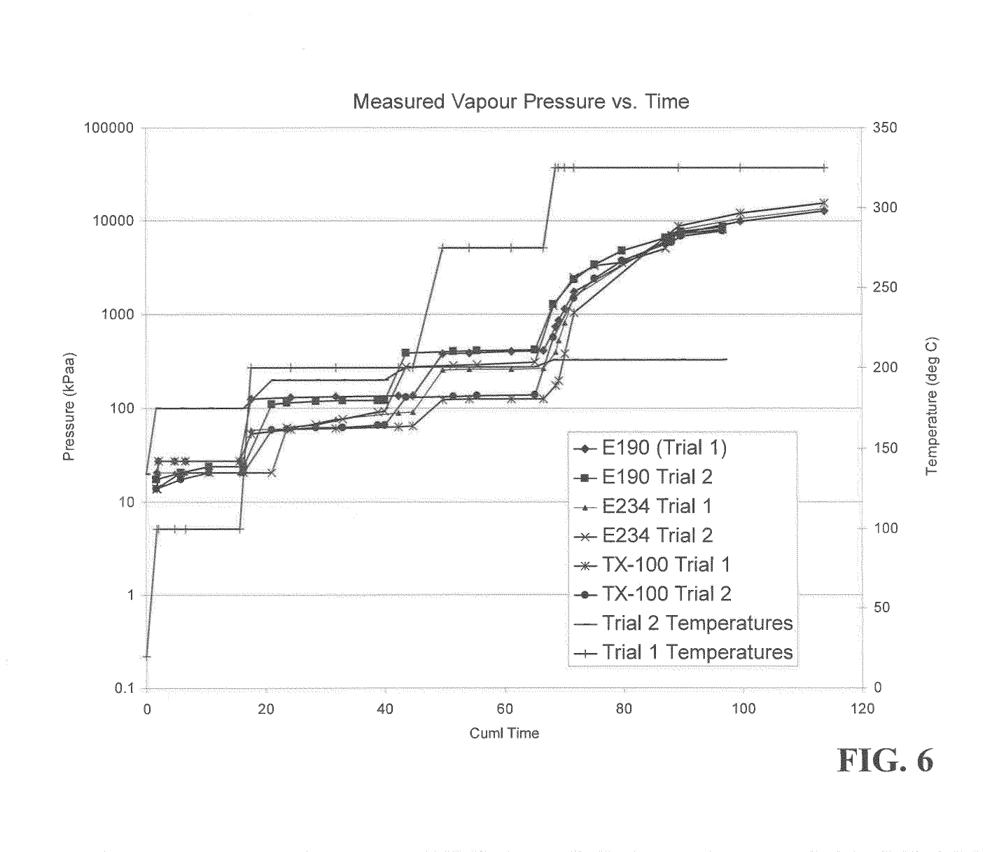

Closed system vapour pressure (absolute pressure in units of kPaa) of TX-100, E-190 and E-234 (all neat) at various temperatures ranging from about 20° C. to about 325° C. was measured using a reactor cylinder placed inside an oven, and additional standard techniques known to a skilled person, in order to determine the suitability of each surfactant for use in the various processes described herein. Two trials were conducted, with results being summarized in Table 10 and FIG. 6.

Vapour pressures (in kPaa) of surfactants T-15-S-9, S-82, S-104PA and C-76 from 20-325° C. were similarly measured and results are shown in Table 11.

TABLE 10

| | | | | |
|---|---|---|---|---|
| Cumulative | | E-234 Pressure | E-190 Pressure | TX-100 |
| Time (h) | T (° C.) | (kPaa) | (kPaa) | Pressure (kPaa) |

Trial 1

| | | | | |
|---|---|---|---|---|
| 0 | 20 | 0.0 | 0.0 | 0.0 |
| 1.83 | 100 | 13.8 | 20.7 | 13.8 |
| 2.08 | 100 | 20.7 | 27.6 | 27.6 |
| 4.75 | 100 | 20.7 | 27.6 | 27.6 |
| 6.58 | 100 | 20.7 | 27.6 | 27.6 |
| 15.6 | 100 | 20.7 | 27.6 | 27.6 |
| 17.5 | 200 | 59.3 | 126.1 | 53.1 |
| 24.25 | 200 | 61.3 | 129.5 | 59.9 |
| 31.7 | 200 | 77.2 | 132.3 | 61.3 |
| 42.2 | 200 | 88.9 | 134.4 | 63.4 |
| 44.7 | 200 | 91.6 | 134.4 | 64.8 |
| 49.7 | 275 | 255.6 | 381.7 | 123.3 |
| 54.2 | 275 | 257.0 | 388.6 | 126.1 |
| 61.2 | 275 | 259.8 | 398.9 | 126.1 |
| 66.6 | 275 | 261.8 | 407.9 | 124.7 |
| 68.7 | 325 | 392.7 | 744.1 | 172.3 |
| 69.2 | 325 | 521.6 | 865.4 | 195.0 |
| 70.2 | 325 | 812.3 | 1132.0 | 375.5 |
| 71.7 | 325 | 1553.7 | 1725.3 | 1031.4 |
| 89.2 | 325 | 7883.5 | 7275.8 | 8688.3 |
| 99.7 | 325 | 10638.2 | 9781.7 | 11988.6 |
| 113.7 | 325 | 13545.7 | 12705.2 | 15557.6 |
| 120.8 | 275 | 10844.9 | 10114.5 | 12663.8 |
| 128.9 | 275 | 10838.0 | 10121.4 | 12670.7 |
| 132.9 | 275 | 10838.0 | 10114.5 | 12663.8 |
| 135.2 | 275 | 10838.0 | 10114.5 | 12663.8 |

Trial 2

| | | | | |
|---|---|---|---|---|
| 0 | 20 | 0.0 | 0.0 | 0.0 |
| 1.7 | 100 | 13.8 | 17.2 | 13.8 |
| 5.7 | 100 | 20.7 | 20.7 | 17.2 |
| 10.5 | 100 | 20.7 | 24.1 | 20.7 |
| 16.3 | 100 | 20.7 | 24.1 | 20.7 |
| 21 | 200 | 20.7 | 110.2 | 58.6 |
| 23.6 | 200 | 62.0 | 114.4 | 59.9 |
| 28.4 | 200 | 66.8 | 117.8 | 62.0 |
| 32.9 | 200 | 77.2 | 119.9 | 62.7 |
| 38.8 | 200 | 90.3 | 120.6 | 65.5 |
| 40 | 200 | 92.3 | 120.6 | 65.5 |
| 43.5 | 275 | 274.9 | 386.5 | 130.2 |
| 51.5 | 275 | 285.9 | 398.2 | 132.3 |
| 55.5 | 275 | 292.8 | 405.8 | 135.0 |
| 65.2 | 275 | 305.2 | 416.8 | 138.5 |
| 68.2 | 325 | 1226.4 | 1288.4 | 565.0 |
| 71.7 | 325 | 2494.2 | 2349.5 | 1481.4 |
| 75.2 | 325 | 3321.0 | 3355.4 | 2397.7 |
| 79.8 | 325 | 3589.7 | 4719.7 | 3741.3 |
| 87.1 | 325 | 5057.3 | 6593.7 | 5684.3 |
| 88.1 | 325 | 6979.6 | 6793.5 | 5904.7 |
| 89.7 | 325 | 7179.4 | 7723.7 | 6855.6 |
| 96.7 | 325 | 8171.5 | 8557.4 | 7785.7 |

The results in Table 10 and FIG. 6 indicate that at about 275° C., the tested surfactants had relatively low vapour pressures, ranging from about 130 kPaa for TX-100 (i.e., least volatile) to about 416 kPaa for E-190.

TABLE 11

| | | T-15-S-9 | S-82 | S-104PA | C-76 |
|---|---|---|---|---|---|
| Cumulative | | Pressure | Pressure | Pressure | Pressure |
| Time (h) | T (° C.) | (kPaa) | (kPaa) | (kPaa) | (kPaa) |
| 0 | 20 | 0.0 | 0.0 | 0.0 | 0.0 |
| 1.33 | 118 | 13.8 | 131.0 | 220.6 | 34.5 |
| 2.5 | 130 | 13.8 | 200.0 | 317.2 | 48.3 |
| 3.9 | 145 | 20.7 | 337.9 | 462.0 | 62.1 |
| 9.82 | 185 | 34.5 | 896.4 | 999.8 | 110.3 |
| 12.02 | 225 | 48.3 | 2227.1 | 1951.3 | 186.2 |
| 15.79 | 225 | 62.1 | 2465.2 | 2281.5 | 206.9 |
| 19.42 | 225 | 75.8 | 2657.1 | 2358.1 | 206.9 |
| 80.95 | 225 | 82.7 | 2716.6 | 2420.1 | 206.9 |
| 86.6 | 225 | 89.6 | 2716.6 | 2440.8 | 206.9 |
| 91.02 | 225 | 89.6 | 2716.6 | 2440.8 | 206.9 |
| 92.84 | 272 | 89.6 | 5378.1 | 3861.2 | 275.8 |
| 97.34 | 275 | 110.3 | 6109.0 | 4578.3 | 310.3 |
| 99.74 | 275 | 131.0 | 6109.0 | 5102.3 | 324.1 |
| 104.44 | 275 | 172.4 | 6205.5 | 5267.8 | 344.8 |
| 108.59 | 275 | 200.0 | 6212.4 | 5343.6 | 365.4 |
| 111.61 | 275 | 227.5 | 6219.3 | 5474.6 | 379.2 |
| 122.48 | 275 | 296.5 | 6219.3 | 5509.1 | 427.5 |
| 125.63 | 275 | 317.2 | 6240.0 | 5536.7 | 441.3 |
| 129.9 | 275 | 351.6 | 6253.8 | 543.6 | 462.0 |
| 134.42 | 275 | 379.2 | 6253.8 | 5543.6 | 482.7 |
| 137.42 | 275 | 393.0 | 6253.8 | 5550.5 | 496.4 |
| 144.09 | 275 | 441.3 | 6253.8 | 5557.4 | 530.9 |
| 148.67 | 275 | 468.9 | 6253.8 | 5557.4 | 558.5 |
| 154.42 | 275 | 522.8 | 6253.8 | 5564.3 | 586.1 |
| 158.45 | 275 | 530.9 | 6253.8 | 5564.3 | 586.1 |
| 163.25 | 304 | 889.5 | 9515.1 | 7294.9 | 848.1 |
| 168.75 | 320 | 2123.7 | 11935.2 | 8377.4 | 1516.9 |
| 173.48 | 321 | 3247.5 | 12018.0 | 8494.6 | 2116.8 |
| 178.88 | 322 | 4247.3 | 12135.2 | 8611.9 | 2682.2 |
| 183.96 | 322 | 5440.2 | 12293.8 | 8825.6 | 3351.0 |
| 189.03 | 323 | 6453.7 | 12293.8 | 8935.9 | 3992.2 |
| 195.12 | 323 | 7646.6 | 12424.8 | 9129.0 | 4909.2 |
| 219.12 | 323 | 11280.2 | 12473.1 | 9618.5 | 8018.9 |
| 243.22 | 324 | 14086.5 | 12528.2 | 10066.7 | 10273.6 |
| 250.25 | 324 | 14803.6 | 12555.8 | 10197.7 | 10818.3 |
| 260.88 | 324 | 15789.6 | 12555.8 | 10383.9 | 11576.7 |
| 269.01 | 325 | 16444.6 | 12555.8 | 10501.1 | 11997.3 |
| 273.24 | 325 | 16761.7 | 12555.8 | 10528.7 | 12300.7 |
| 279.52 | 325 | 17216.8 | 12555.8 | 10659.7 | 12638.5 |
| 288.54 | 325 | 17796.0 | 12562.7 | 10797.6 | 12686.6 |
| 293.54 | 325 | 18078.7 | 12555.8 | 10866.5 | 13279.8 |
| 300.52 | 325 | 18444.1 | 12555.8 | 10956.2 | 13548.7 |
| 309.44 | 325 | 18878.5 | 12555.8 | 11080.3 | 13859.0 |
| 315.61 | 325 | 19140.5 | 12555.8 | 11163.0 | 14045.1 |
| 317.66 | 325 | 19223.3 | 12555.8 | 11190.6 | 14107.2 |
| 327.68 | 325 | 19630.1 | 12555.8 | 11335.4 | 14389.9 |
| 332.73 | 325 | 19871.4 | 12555.8 | 11438.8 | 14541.6 |
| 343.6 | 325 | 20209.2 | 12555.8 | 11562.9 | 14782.9 |
| 348.1 | 325 | 20319.6 | 12555.8 | 11604.3 | 14865.6 |

If the vapour pressures of the steam at 225, 275 and 325° C. are known (2555.0, 5950.0 and 12000.0 kPa, respectively), a skilled person may readily determine the fraction of surfactant vapour in the steam vapour at a given temperature and the fraction may be expressed as a mole percentage or in ppm.

### Example 4

### Surfactant Vapourization Studies at Various Steam Temperatures

To determine the level of vapourization of the surfactants at various steam temperatures, steam from distilled water was pumped into a test cylinder, which was placed in an oven heated to 260° C. A surfactant of known concentration was also injected into the test cylinder at a pressure above the vapour pressure of the distilled water at a specified temperature. For example, about 295° C. was used for the less volatile TX-100, and about 275° C. for surfactants E-190 and E-234. The pressure in the test cylinder was then dropped to the water saturation pressure. A mixture of steam and surfactant was captured and was subsequently cooled to room temperature at about 20° C. in a condensor. Samples were collected at defined time increments and subjected to the IFT measurements as described in Example 1. The objective was to measure the reduction in IFT from the baseline, and hence, the effective concentration of the surfactant that was vapourized in the steam phase (i.e., the level of vapourization).

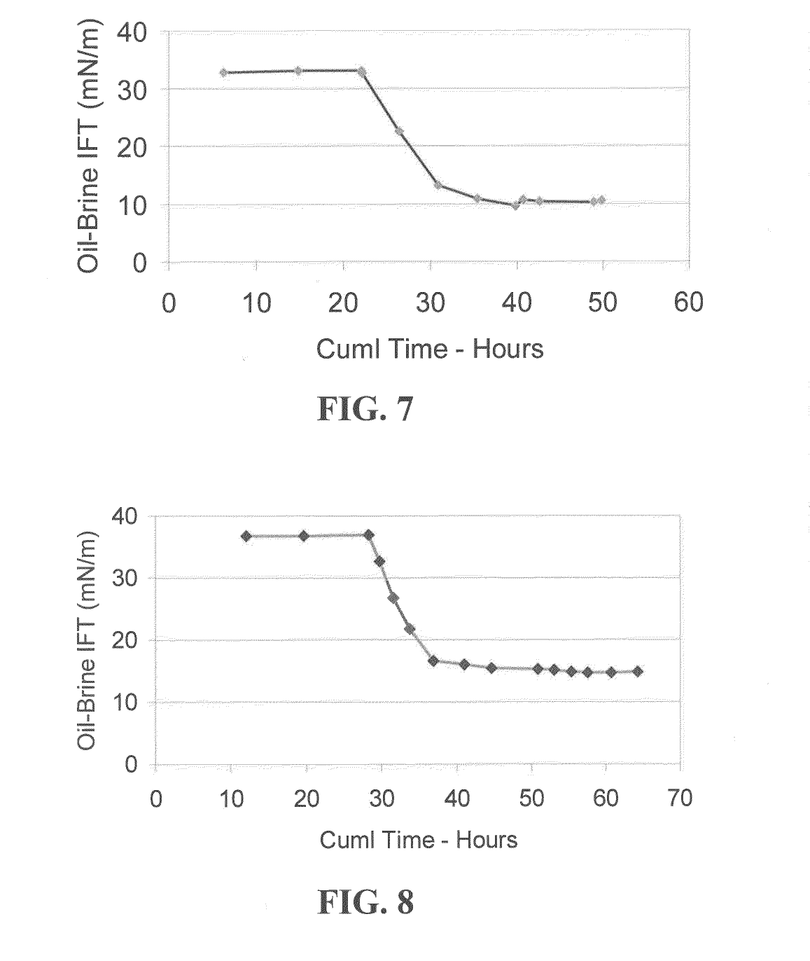

Results for vapourization of TX-100 in the steam phase (at about 295° C.) are shown in Table 12 and FIG. 7.

TABLE 12

| | | | Total | | Avg. | Concen- |
|---|---|---|---|---|---|---|
| | | Total | Sur- | Avg. | IFT | tration |
| | Total | H₂O | factant | IFT | (Sample- | of |
| | Time | Injected | Injected | (H₂O-Oil) | Oil) | TX-100 |
| Sample # | (h) | (mL) | (mL) | (mN/m) | (mN/m) | (mg/L) |
| Baseline 1 | 6.25 | 1250.70 | 0.00 | 33.38 | 32.76 | 0 |
| Baseline 2 | 14.75 | 2956.60 | 0.00 | 33.38 | 33.01 | 0 |
| Baseline 3 | 22.00 | 4385.90 | 0.00 | 33.38 | 32.97 | 0 |
| 1 | 22.10 | 4410.50 | 0.01 | 33.38 | 32.65 | 1.3 |
| 5 | 26.40 | 5281.00 | 0.44 | 33.38 | 22.50 | 39.0 |
| 10 | 30.90 | 6178.50 | 0.89 | 33.38 | 13.13 | 73.0 |
| 15 | 35.40 | 7074.50 | 1.34 | 33.38 | 10.86 | 81.0 |
| 20 | 39.80 | 7965.40 | 1.78 | 33.38 | 9.65 | 81.0 |
| 21 | 40.75 | 8143.50 | 1.88 | 33.38 | 10.68 | 81.0 |
| 23 | 42.60 | 8502.60 | 2.08 | 33.38 | 10.38 | 81.0 |
| 30 | 48.90 | 9781.30 | 2.69 | 33.38 | 10.28 | 81.0 |
| 31 | 49.75 | 9935.30 | 2.72 | 33.38 | 10.45 | 81.0 |

Experimental conditions are summarized as follows:
Water Injection Rate=200 mL/h for the entire test run (26 h)
TX-100 Injection Rate=0.1 mL/h for the entire test run
Injection Pump Pressure=8130 kPag
Mixing Vessel Pressure=7971 kPag
Temperature of Mixing Vessel=297° C.

The results suggest a stable oil-sample IFT of about 10 mN/m, which equates to an effective TX-100 concentration of about 81 ppm. This indicates that about 16% of the injected surfactant was vapourized in the steam phase at about 295° C.

Results for vapourization of E-234 in the steam phase (at about 275° C.) are shown in Table 13 and FIG. 8.

TABLE 13

| | | | Total | Avg. | Avg. | Concen- |
|---|---|---|---|---|---|---|
| | | Total | Sur- | IFT | IFT | tration |
| | Total | H₂O | factant | (H₂O- | (Sample- | of |
| | Time | Injected | Injected | Oil) | Oil) | E-234 |
| Sample # | (h) | (mL) | (mL) | (mN/m) | (mN/m) | (ppm) |
| Baseline 1 | 12.04 | 1203.48 | 0.00 | 36.90 | 36.80 | 0 |
| Baseline 2 | 19.54 | 1954.88 | 0.00 | 36.90 | 36.80 | 0 |
| Baseline 3 | 28.19 | 2819.19 | 0.00 | 36.90 | 36.90 | 0 |
| 1 | 29.76 | 2976.50 | 0.31 | 36.90 | 32.60 | 45 |
| 3 | 31.52 | 3152.98 | 0.67 | 36.90 | 26.70 | 120 |
| 6 | 33.69 | 3369.20 | 1.10 | 36.90 | 21.80 | 320 |
| 9 | 36.83 | 3683.66 | 1.73 | 36.90 | 16.60 | 1140 |
| 12 | 41.03 | 4103.10 | 2.57 | 36.90 | 16.00 | 1350 |
| 15 | 44.73 | 4473.65 | 3.31 | 36.90 | 15.50 | 1570 |
| 18 | 50.88 | 5088.20 | 4.54 | 36.90 | 15.30 | 1670 |
| 21 | 53.12 | 5312.40 | 4.99 | 36.90 | 15.10 | 1770 |
| 24 | 55.42 | 5542.00 | 5.45 | 36.90 | 14.90 | 1890 |
| 27 | 57.57 | 5757.77 | 5.88 | 36.90 | 14.70 | 1950 |
| 30 | 60.69 | 6069.10 | 6.50 | 36.90 | 14.70 | 1950 |
| 33 | 64.24 | 6424.10 | 7.21 | 36.90 | 14.80 | 1930 |

Experimental conditions are summarized as follows:
Water Injection Rate=100 mL/h for the entire test run (64.2 h)
E-234 Injection Rate=0.2 mL/h for the entire test run (64.2 h)
Injection Pump Pressure=5500 kPag
Mixing Vessel Pressure=5494 kPag
Temperature of Mixing Vessel=275° C.

The results suggest a stable oil-sample IFT of about 15 mN/m, which equates to an effective E-234 concentration of about 2000 ppm. This indicates that about 97.5% of the injected E-234 was vapourized into the steam phase at 275° C.

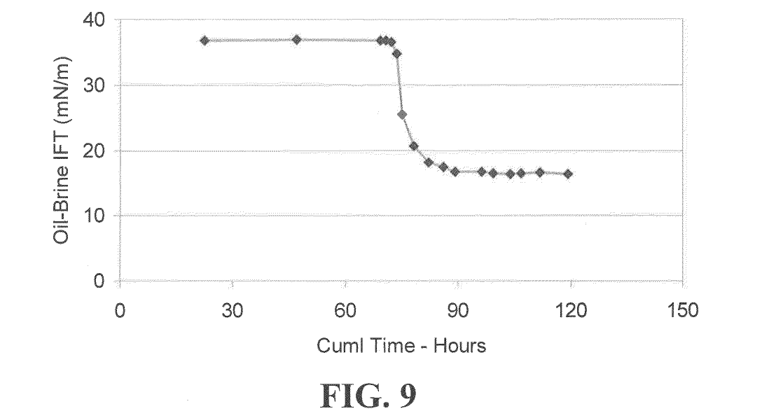

Results for vapourization of E-190 in the steam phase (at about 275° C.) are shown in Table 14 and FIG. 9. The results suggest that almost 100% of E-190 was vapourized into the steam phase at 275° C.

TABLE 14

| | | | Total | Avg. | Avg. | Concen- |
|---|---|---|---|---|---|---|
| | | Total | Sur- | IFT | IFT | tration |
| | Total | H₂O | factant | (H₂O- | (Sample- | of |
| | Time | Injected | Injected | Oil) | Oil) | E-190 |
| Sample # | (h) | (mL) | (mL) | (mN/m) | (mN/m) | (ppm) |
| Baseline 1 | 22.50 | 2251.10 | 0.00 | 36.90 | 36.80 | 0.00 |
| Baseline 2 | 47.00 | 4702.30 | 0.00 | 36.90 | 36.90 | 0.00 |
| Baseline 3 | 69.10 | 6913.20 | 0.00 | 36.90 | 36.80 | 0.00 |
| 1 | 70.60 | 7061.10 | 0.30 | 36.90 | 36.80 | 0.00 |
| 3 | 72.10 | 7212.30 | 0.59 | 36.90 | 36.50 | 0.00 |
| 6 | 73.60 | 7361.40 | 0.88 | 36.90 | 34.70 | 70.00 |
| 9 | 75.10 | 7513.40 | 1.14 | 36.90 | 25.60 | 300.00 |
| 12 | 78.10 | 7814.50 | 2.29 | 36.90 | 20.60 | 900.00 |
| 15 | 82.10 | 8215.60 | 3.06 | 36.90 | 18.20 | 1400.00 |
| 18 | 86.10 | 8617.50 | 3.91 | 36.90 | 17.40 | 1750.00 |
| 21 | 89.10 | 8919.40 | 4.43 | 36.90 | 16.70 | 1950.00 |
| 24 | 96.10 | 9621.10 | 5.34 | 36.90 | 16.70 | 1950.00 |
| 27 | 99.40 | 9953.40 | 6.15 | 36.90 | 16.50 | 2000.00 |
| 30 | 103.90 | 10409.00 | 6.69 | 36.90 | 16.40 | 2000.00 |
| 33 | 106.70 | 10688.10 | 7.47 | 36.90 | 16.50 | 2000.00 |
| 36 | 111.80 | 11198.30 | 8.49 | 36.90 | 16.60 | 2000.00 |
| 39 | 119.21 | 11941.30 | 9.80 | 36.90 | 16.40 | 2000.00 |

Experimental conditions are summarized as follows:
Water Injection Rate=100 mL/h for the entire test run (119 h)
E-190 Injection Rate=0.2 mL/h for the entire test run (119 h)
Injection Pump Pressure=5500 kPag
Mixing Vessel Pressure=5494 kPag
Temperature of Mixing Vessel=275° C.

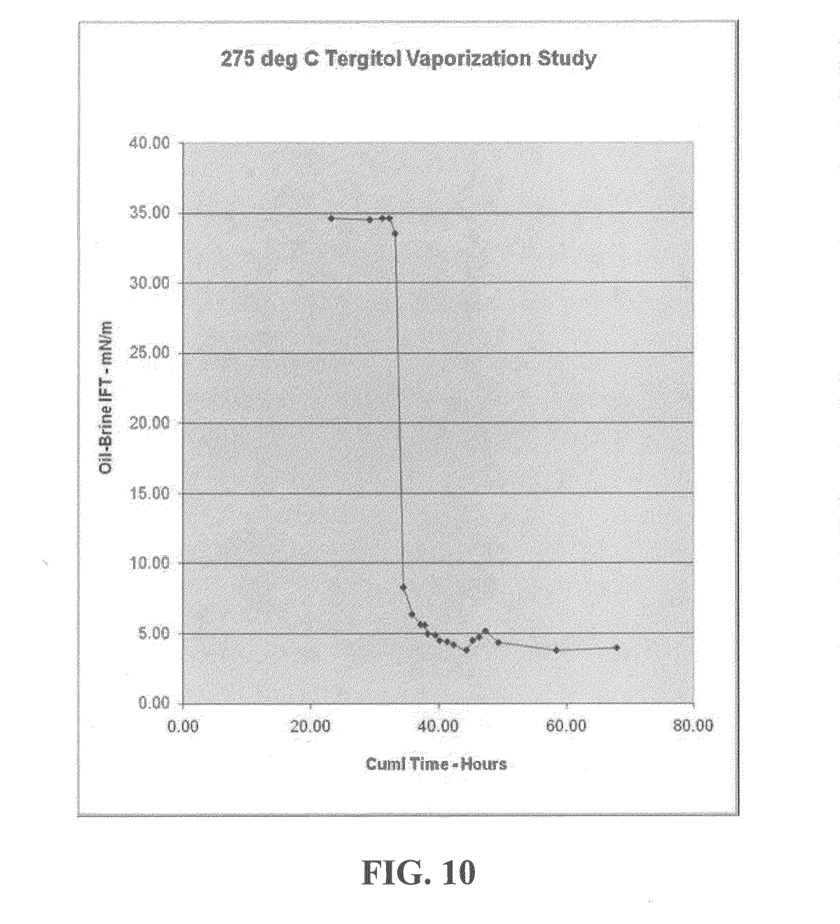

Results for vapourization of T-15-S-9 in the steam phase (at about 275° C.) are shown in Table 15 and FIG. 10. The results suggest that almost 100% of T-15-S-9 was vapourized into the steam phase at 275° C.

TABLE 15

| | | | | Avg. | | |
|---|---|---|---|---|---|---|
| | | Total | Total | IFT | Avg. IFT | Concen- |
| | Total | H₂O | Surfactant | (H₂O- | (Sample- | tration of |
| | Time | Injected | Injected | Oil) | Oil) | T-15-S-9 |
| Sample # | (h) | (mL) | (mL) | (mN/m) | (mN/m) | (ppm) |
| Baseline 1 | 23.25 | 2320.00 | 0.00 | 34.60 | 34.60 | 0.00 |
| Baseline 3 | 29.26 | 2918.00 | 0.00 | 34.60 | 34.50 | 0.00 |
| Baseline 5 | 31.24 | 3118.00 | 0.00 | 34.60 | 34.60 | 0.00 |
| 11 | 32.30 | 3215.00 | 0.00 | 34.60 | 34.60 | 50.00 |
| 13 | 33.20 | 3301.80 | 0.35 | 34.60 | 33.50 | 250.00 |
| 16 | 34.50 | 3457.43 | 0.62 | 34.60 | 8.29 | 500.00 |
| 19 | 35.85 | 3602.68 | 0.90 | 34.60 | 6.37 | 700.00 |
| 22 | 37.19 | 3749.00 | 1.20 | 34.60 | 5.64 | 800.00 |
| 23 | 37.80 | 3792.80 | 1.30 | 34.60 | 5.61 | 900.00 |
| 24 | 38.30 | 3857.07 | 1.40 | 34.60 | 4.98 | 1000.00 |
| 25 | 39.45 | 3947.00 | 1.52 | 34.60 | 4.88 | 1000.00 |
| 26 | 40.12 | 4036.00 | 1.68 | 34.60 | 4.5 | 1000.00 |
| 27 | 41.30 | 4134.11 | 1.77 | 34.60 | 4.41 | 1000.00 |
| 28 | 42.30 | 4225.80 | 1.97 | 34.60 | 4.20 | 1500.00 |
| 30 | 44.30 | 4426.00 | 2.37 | 34.60 | 3.82 | 1500.00 |
| 31 | 45.30 | 4537.00 | 2.57 | 34.60 | 4.51 | 1500.00 |
| 32 | 46.30 | 4636.00 | 2.76 | 34.60 | 4.74 | 1750.00 |
| 33 | 47.30 | 4717.00 | 2.97 | 34.60 | 5.18 | 1750.00 |
| 35 | 49.30 | 4917.00 | 3.37 | 34.60 | 4.35 | 1900.00 |
| 43 | 58.32 | 5730.00 | 5.17 | 34.60 | 3.80 | 2000.00 |
| 51 | 67.80 | 6721.00 | 7.27 | 34.60 | 3.97 | 2000.00 |

Experimental conditions are summarized as follows:
Water Injection Rate=100 mL/h for the entire test run (67 h)
T-15-S-9 Injection Rate=0.2 mL/h for the entire test run (67 h)
Injection Pump Pressure=5500 kPag
Mixing Vessel Pressure=5494 kPag
Temperature of Mixing Vessel=275° C.

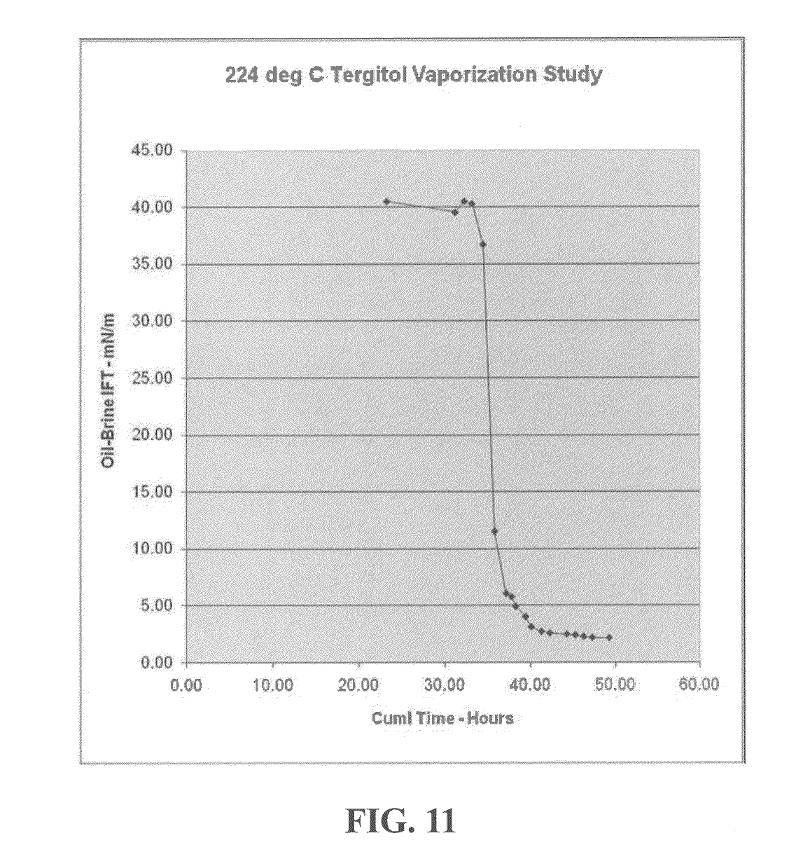

In various embodiments of the invention, a lower temperature of about 225° C. may be more typical of a surfactant injection operation; therefore, a second vaporization test was conducted with T-15-S-9 at about 225° C. to study the effect of temperature on volatility. The results are shown in Table 16 and FIG. 11. FIG. 11 indicates that almost 100% of T-15-S-9 was vapourized into the steam phase at about 225° C.

TABLE 16

| | | | Total | Avg. | Avg. | Concen- |
|---|---|---|---|---|---|---|
| | | Total | Sur- | IFT | IFT | tration |
| | Total | H₂O | factant | (H₂O- | (Sample- | of |
| | Time | Injected | Injected | Oil) | Oil) | T-15-S-9 |
| Sample # | (h) | (mL) | (mL) | (mN/m) | (mN/m) | (ppm) |
| Baseline 3a | 23.25 | 614.07 | 0.00 | 73.50 | 40.50 | 0.00 |
| Baseline 9 | 31.24 | 8465.89 | 0.00 | 73.50 | 39.55 | 0.00 |
| Baseline 12 | 32.30 | 8757.53 | 0.00 | 73.50 | 40.51 | 0.00 |
| Baseline 15 | 33.20 | 9059.38 | 0.00 | 73.50 | 40.30 | 0.00 |
| 18 | 34.50 | 9211.40 | 0.20 | 73.50 | 36.70 | 1315.00 |
| 21 | 35.85 | 9359.40 | 0.50 | 73.50 | 11.50 | 2027.00 |
| 24 | 37.19 | 9509.40 | 0.80 | 73.50 | 6.05 | 2000.00 |
| 27 | 37.80 | 9659.40 | 1.10 | 73.50 | 5.77 | 2000.00 |
| 30 | 38.30 | 9959.38 | 1.70 | 73.50 | 4.90 | 2000.13 |
| 33 | 39.45 | 10259.40 | 2.30 | 73.50 | 4.00 | 2000.00 |
| 36 | 40.12 | 10559.40 | 2.90 | 73.50 | 3.10 | 2000.00 |
| 39 | 41.30 | 10859.40 | 3.50 | 73.50 | 2.70 | 2000.00 |
| 42 | 42.30 | 11159.40 | 4.10 | 73.50 | 2.55 | 2000.00 |
| 45 | 44.30 | 11459.40 | 4.70 | 73.50 | 2.46 | 2000.00 |
| 48 | 45.30 | 11759.40 | 5.30 | 73.50 | 2.40 | 2000.00 |
| 51 | 46.30 | 12059.40 | 5.90 | 73.50 | 2.25 | 2000.00 |
| 54 | 47.30 | 12359.40 | 6.50 | 73.50 | 2.17 | 2000.00 |
| 57 | 49.30 | 12659.30 | 7.10 | 73.50 | 2.14 | 2000.67 |

Experimental conditions are summarized as follows:
Water Injection Rate=100 mL/h for the entire test run (72.2 h)
T-15-S-9 Injection Rate=0.2 mL/h for the entire test run (72.2 h)
Injection Pump Pressure=2482 kPag
Mixing Vessel Pressure=2413 kPag
Temperature of Mixing Vessel=224° C.

### Example 5

### Viscosity Studies

Bitumen (hydrocarbon) samples from various sources were cleaned to less than about 2% water by volume and sediment content via ultracentrifuge prior to viscosity testing. Viscosity data from clean bitumen source 1 and source 2 measured at a shear rate of 5 rpm in a Brookfield viscosity meter at 60° C. (see Table 17).

TABLE 17

| | Apparent Viscosity | Apparent Viscosity of |
|---|---|---|
| | of Clean Bitumen | Clean Bitumen |
| Temperature | Source 1 | Source 2 |
| (° C.) | (mPa · s) | (mPa · s) |
| 60 | 2587 | 4205 |

As will be understood by a skilled person, a surfactant suitable for enhanced oil recovery (EOR) should generate a water external emulsion with a viscosity lower than that of the original bitumen under the same conditions.

The viscosity effect of TX-100 was studied at about 50° C. and under ambient pressure and a shear rate of 0.5-5 rpm. TX-100 at a concentration of about 250 mg/L in water was added to an emulsion comprising 50% by volume water and 50% by volume clean bitumen source 1. The emulsion was found stable for about 96 h. It was observed that at a concentration of about 250 mg/L TX-100 in water and at about 50° C. and ambient pressure, TX-100 was capable of generating a long term stable emulsion (water external) comprising about 50% by volume bitumen and about 50% by volume water.

The viscosity effect of MEA was similarly studied at about 60° C. and ambient pressure. The concentration of MEA was about 250 mg/L in distilled water in an emulsion comprising about 50% by volume water and about 50% clean bitumen source 1. Results are shown in Table 18. The results suggest that MEA caused a viscosity reduction under the conditions studied (an emulsion comprising 50% by volume water and 50% by volume bitumen, at about 60° C. and ambient pressure), which would be associated with a water external emulsion.

TABLE 18

| | | Apparent Viscosity of Clean |
|---|---|---|
| | | Bitumen Source 1 in the |
| Brookfield Rotation Rate | | Presence of MEA (mPa · s) |
| (rpm) | % Torque | After 24 h |
| 0.5 | 13 | 31433 |
| 1.0 | 12.2 | 14637 |
| 2.0 | 8.3 | 4979 |
| 2.5 | 6.7 | 3215 |
| 4.0 | 6.4 | 2070 |
| 5.0 | 6.3 | 1608 |

The viscosity effect of TX-100 was further studied at 60° C. under ambient pressure using an unknown concentration of TX-100 in water. Specifically, 100 L of distilled water and about 300 L of TX-100 were placed in a 500 L reactor and the mixture was heated to about 260° C. Once the pressure had stabilized, the top valve on the reactor was cracked and all of the water phase was allowed to escape (along with any TX-100 that was volatilized in the water phase) into an external condenser where all of the liquid was collected. The condensed fluid thus obtained was then used as the water phase for an emulsion comprising 45% by volume bitumen source 2 and 55% by volume water (unknown TX-100 concentration). Upon the addition of TX-100, the emulsion was stable for 24 h. The results of this viscosity study are shown in Table 19.

TABLE 19

| | | Apparent Viscosity of Clean |
|---|---|---|
| | | Bitumen Source 1 in the |
| Brookfield Rotation Rate | | Presence of TX-100 (mPa · s) |
| (rpm) | % Torque | After 24 h |
| 0.5 | 8.6 | 20876 |
| 1.0 | 8.7 | 10438 |
| 2.0 | 8.8 | 5279 |
| 2.5 | 9.6 | 4607 |
| 4.0 | 11 | 3299 |
| 5.0 | 13.5 | 3239 |

According to Table 19, the viscosity of the TX-100 added emulsion at about 5 RPM at about 60° C. was about 3239 mPa·s, which is less than the viscosity of the baseline clean bitumen source 2 (about 4205 mPa·s). This suggests that the vapourized TX-100 may be effective in reducing the viscosity of the emulsion by forming a water external emulsion.

A similar test was conducted using a different ratio of water to TX-100 in the original reactor (about 100 mL of distilled water and about 200 mL of TX-100 heated to about 260° C.), and showed similar results based on the visual appearance of the resulting emulsion, which was formed from about 45% bitumen and about 55% TX-100 in water.

The viscosity effect of T-15-S-9 was similarly studied at about 60° C. under ambient pressure. A condensed fluid comprising 100 mL water and condensed T-15-S-9 from the vapours) was used as the water phase of an emulsion comprising about 45% by volume bitumen source 1 and about 55% by volume water. The T-15-S-9 added emulsion was stable for about 24 h. Results are shown in Table 20.

TABLE 20

| | | Apparent Viscosity of Clean |
|---|---|---|
| | | Bitumen Source 1 in the |
| Brookfield Rotation Rate | | Presence of T-15-S-9 (mPa · s) |
| (rpm) | % Torque | After 24 h |
| 0.5 | 7.5 | 1796 |
| 1.0 | 7.4 | 8858 |
| 2.0 | 4.8 | 3059 |
| 2.5 | 4.5 | 1248 |
| 4.0 | 2.3 | 929 |
| 5.0 | 2.2 | 767.8 |

The results indicate that the viscosity of the emulsion was less than about 25% of that of the original clean bitumen, suggesting the formation of a water external emulsion.

A further series of emulsion viscosity tests were conducted using bitumen source 2 and about 2000 ppm T-15-S-9 in an emulsion comprising about 60 by volume water and about 40% by volume bitumen. The surfactant was dissolved into the water first and then mixed with the bitumen using two methods. In the first method, water was slowly added to neat bitumen while mixing to obtain a stable emulsion at about 60° C. In the second method, neat bitumen was slowly added to water while mixing in combination with about 2000 ppm T-15-S-9. Uniform stable emulsions were generated using both methods. The emulsion obtained from the first method had a ratio of about 45% bitumen to about 55% condensate from a T-15-S-9 volatilization test at about 60° C. The emulsion obtained from the second method was composed of about 40% bitumen, about 60% water and about 2000 ppm T-15-S-9.

Based on Examples 1, 3 and 5, T-15-S-9 appears to be volatile, a strong IFT reducer, and able to generate a stable low viscosity water external emulsion, and therefore may be suitable for use in the various embodiments of the invention described herein.

### Example 6

### Static Adsorption Testing

Static adsorption tests were conducted to determine the extent of surfactant losses due to adsorption to sand grains in bitumen source 1 at high temperature and high pressure. The surfactants studied included T-15-S-9, E-190, E-234, S-82, S-104PA and C-76.

In a typical experiment, two cylinders were each charged with about 300 g of homogenized oil sands core sample from a selected reservoir source. Each cylinder was evacuated for about 2 h to remove gas from the system. The cylinders were then placed in a high temperature oven and shaken vigorously once every 8 h. The cylinders were then heated to about 225° C. About 300 L of distilled water with a surfactant concentration of about 2000 mg/L was injected into each cylinder. The pressure in each cylinder was expected to be close to the steam pressure at 225° C. Immediately after injection of water and the surfactant, the cylinders were rotated to mix water and the surfactant with the oil sands (e.g., about every 6 h for a 24 h period). The cylinders were cooled to room temperature and free water was removed from the cylinders without removing any sands. The IFT was measured between the removed water and refined mineral oil in accordance with Example 1. The surfactant content in the removed water after high temperature adsorption was then determined based on these measurements. The results are shown in Table 21.

TABLE 21

| | | Final | Final | Mass of |
|---|---|---|---|---|
| | | Surfactant | Surfactant | Surfactant |
| | Trial | Concentration | Mass | Loss |
| Surfactant | # | (mg/L) | (mg) | (mg) |
| TERGITOL ™ 15-S-9 | 1 | 2000 | 600 | 0 |
| TERGITOL ™ 15-S-9 | 2 | 1950 | 585 | 15 |
| NOVELFROTH ™ 190 | 1 | 600 | 180 | 420 |
| NOVELFROTH ™ 190 | 2 | 550 | 165 | 435 |
| NOVELFROTH ™ 234 | 1 | 175 | 52.5 | 547.5 |
| NOVELFROTH ™ 234 | 2 | 175 | 52.5 | 547.5 |
| SURFYNOL ™ 82 | 1 | 1850 | 555 | 45 |
| SURFYNOL ™ 82 | 2 | 1900 | 570 | 30 |
| SURFYNOL ™ 104PA | 1 | 0 | 0 | 600 |
| SURFYNOL ™ 104PA | 2 | 0 | 0 | 600 |
| CARBOWET ™ 76 | 1 | 350 | 105 | 495 |
| CARBOWET ™ 76 | 2 | 400 | 120 | 480 |

The results indicate virtually zero adsorption losses with T-15-S-9 and S-82, indicating that these surfactants did not cause substantial IFT reduction in the refined oil-water system and thus T-15-S-9 and S-82 may be suitable surfactants for use in the various embodiments of the invention.

E-234, and to a slightly lesser extent C-76 and E-190, had relatively significant adsorption losses after the high temperature static testing, indicating that significantly higher concentrations of these surfactants would be required in a field application to generate a low IFT condition. The concentrations of S-82 and C-76 within the oleic phase were not assessed.

### Example 7

### Coreflood Tests

Five coreflood tests on identical homogenized cleaned oil sandpacks of 3.81 cm length were conducted with sample solutions containing different sample surfactants in water (2,000 mg/L).

In a typical experiment, a homogenized oil sandpack was prepared with about 10% initial water saturation and 90% bitumen saturation. The pack was then flooded with cleaned (water free) oil from bitumen source 1 at both 80° C. and 225° C. to evaluate the initial permeability to bitumen, which was found to be 5400 mD (millidarcy) at 80° C., and 4100 mD at 225° C. (the second value is slightly lower due to connate water thermal expansion effects and thermal grain expansion effects).

Representative oil sandpack and test parameters are listed below:

| | |
|---|---|
| Sand Status | Cleaned/Homogenized |
| Oil Source | Bitumen source 1 |
| Pack Length | 40 cm |
| Pack Diameter | 3.81 cm |
| Pack Flow Area | 11.4 cm² |
| Pack Porosity | 0.38 frac |
| Pack Pore Volume | 173.28 cm³ |
| Test Temperature | 225° C. |
| Test Pore Pressure | 3450 kPag |
| Test Overburden Pressure | 7000 kPag |

The first test conducted was a baseline run with no surfactant added, and the second test used 2000 ppm T-15-S-9 in the fresh water phase.

The procedure for T-15-S-9 testing was repeated using each of 2000 ppm E-190, S-82, and C-76.

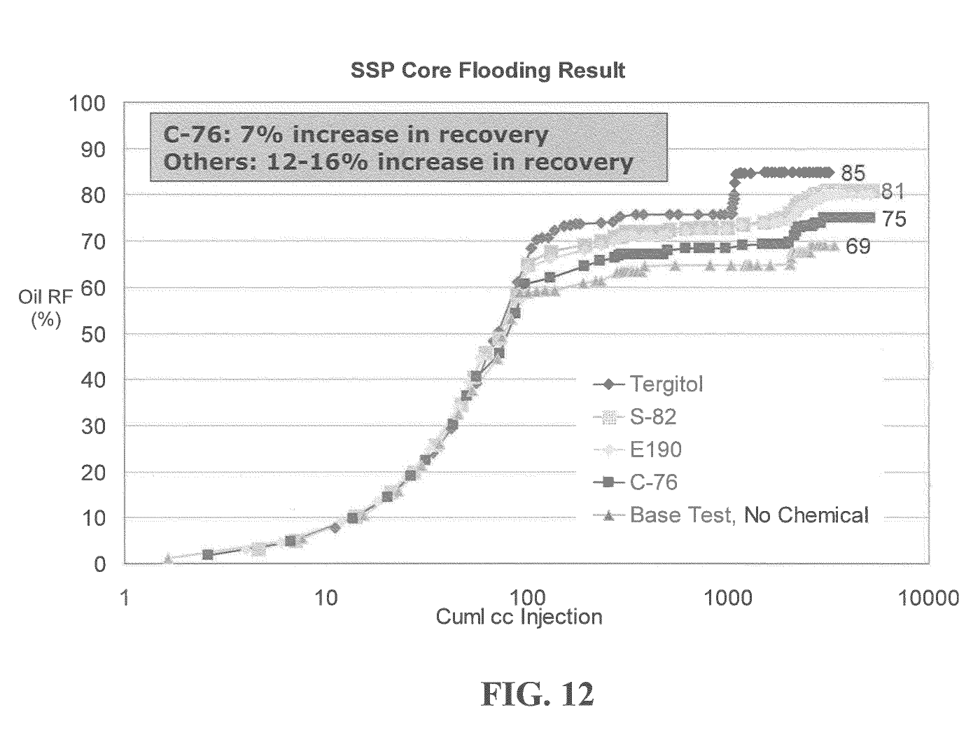

Comparative results from the tests for both permeability and percent recovery of original oil in place (OOIP) as a function of cumulative volume of water/steam injected are summarized in FIG. 12. It was observed that all tested surfactants (T-15-S-9, S-82, E-190 and C-76) improved oil recovery rate.

These results suggest that T-15-S-9 appeared to have a significant effect on both the rate of oil recovery and the reduction of final residual oil saturation. Test 2 recovered about 10% additional OOIP on pure waterflood at 225° C. in contrast to the baseline test, and almost 16% overall incremental percent recovery of OOIP when the steamflood phase was taken into consideration. Thus, T-15-S-9 appeared to improve thermal recovery performance in both hot water and steam displacement modes. Without being limited to any theory, the enhanced performance was probably due to reduced residual oil saturation, enhanced relative permeability, IFT reduction, and perhaps wettability alteration in the presence of T-15-S-9.

It will be understood that any range of values herein is intended to specifically include any intermediate value or sub-range within the given range, and all such intermediate values and sub-ranges are individually and specifically disclosed.

It will also be understood that the word “a” or “an” is intended to mean “one or more” or “at least one”, and any singular form is intended to include plurals herein.

It will be further understood that the term “comprise”, including any variation thereof, is intended to be open-ended and means “include, but not limited to,” unless otherwise specifically indicated to the contrary.

When a list of items is given herein with an “or” before the last item, any one of the listed items or any suitable combination of two or more of the listed items may be selected and used.

Of course, the above described embodiments of the invention are intended to be illustrative only and in no way limiting. The described embodiments of the invention are susceptible to many modifications of form, arrangement of parts, details and order of operation. The invention, rather, is intended to encompass all such modification within its scope, as defined by the claims.

1. A process of increasing recovery rate of hydrocarbon from a reservoir of bituminous sands, the process comprising:
softening bitumen in a region in the reservoir to generate a fluid comprising a hydrocarbon, to allow the fluid to drain by gravity from the region into a production well below the region for recovery of the hydrocarbon; and
providing vapour of a compound to the region, and allowing the compound to disperse and condense in the region,
wherein the compound is represented by 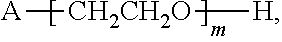
wherein
(i) m is 1, and A is —NH₂ or —N(H)CH₂CH₂OH; or
(ii) m is 1 or greater than 1, and A is —OR₁, R₁ being an alkyl group.

2. The process of claim 1, wherein softening bitumen in the region comprises injecting steam or a solvent into the region.

3. The process of claim 1, wherein softening bitumen in the region comprises heating bitumen in the region.

4. The process of claim 1, wherein the compound is a primary, secondary, or tertiary alcohol ethoxylate.

5. The process of claim 1, wherein R₁ is a linear or branched alkyl group having more than 5 carbon atoms, and m is greater than 1.

6. The process of claim 4, wherein the alcohol ethoxylate has the formula of
C₁₂₋₁₄H₂₅₋₂₉O[CH₂CH₂O]₉H;
C₁₂₋₁₅H₂₅₋₃₁O[CH₂CH₂O]_{2.8}H; 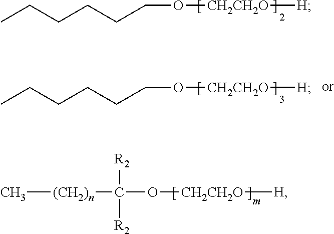
wherein
m is 2 or 3,
n is 2 or 3, and
R₂ is methyl or ethyl.

7. The process of claim 4, wherein the vapour of the alcohol ethoxylate is provided to the region at a partial pressure of about 85 kPa to about 590 kPa and a temperature from about 225° C. to about 275° C.

8. The process of claim 1, wherein the vapour of the compound is provided to the region with steam from an injection well.

9. The process of claim 8, wherein the compound is an alcohol ethoxylate, and the steam is at a temperature from about 225° C. to about 275° C. in the injection well, and the molar ratio of the vapour of the alcohol ethoxylate to the steam in the injection well is about 0.03:1 to about 0.1:1.

10. The process of claim 8, wherein the steam is at a temperature from about 160° C. to about 310° C. and a pressure of about 600 kPa to 10 MPa in the injection well.

11. The process of claim 8, wherein the compound is an alcohol ethoxylate, and the volume ratio of the alcohol ethoxylate to the steam, measured at room temperature on a liquid basis, is about 10 ppm to about 2000 ppm, or is about 10 ppm to about 8000 ppm when the alcohol ethoxylate is a secondary alcohol ethoxylate.

12. The process of claim 1, comprising providing a solvent to the region, wherein the solvent comprises an alkane having at least 3 carbons and the weight ratio of the solvent to the steam is less than 1%.

13. The process of claim 1, comprising further providing a tertiary acetylenic diol to the region.

14. A mixture for injection into a reservoir of bituminous sands to recover hydrocarbon from the reservoir, the mixture comprising:
steam at a temperature from about 160° C. to about 310° C. and a pressure of about 600 kPa to 10 MPa; and
vapour of a compound,
wherein the compound is represented by 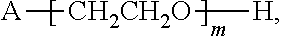
wherein
(i) m is 1, and A is —NH₂ or —N(H)CH₂CH₂OH; or
(ii) m is 1 or greater than 1, and A is —OR₁, R₁ being an alkyl group.

15. The mixture of claim 14, wherein the compound is a primary, secondary, or tertiary alcohol ethoxylate.

16. The mixture of claim 14, wherein R₁ is a linear or branched alkyl group having more than 5 carbon atoms, and m is greater than 1.

17. The mixture of claim 15, wherein the alcohol ethoxylate has the formula of
C₁₂₋₁₄H₂₅₋₂₉O[CH₂CH₂O]₉H;
C₁₂₋₁₅H₂₅₋₃₁O[CH₂CH₂O]_{2.8}H; 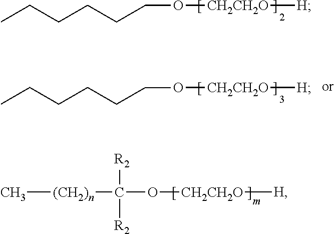
wherein
m is 2 or 3,
n is 2 or 3, and
R₂ is methyl or ethyl.

18. The mixture of claim 15, wherein the steam is at a temperature from about 225° C. to about 275° C. and the vapour of the alcohol ethoxylate has a partial pressure of about 85 kPa to about 590 kPa.

19. The mixture of claim 15, wherein the steam is at a temperature from about 225° C. to about 275° C., and wherein the volume ratio of the alcohol ethoxylate to the steam, measured at room temperature on a liquid basis, is about 10 ppm to about 2000 ppm, or is about 10 ppm to about 8000 ppm when the alcohol ethoxylate is a secondary alcohol ethoxylate.

20. The mixture of claim 14, further comprising a solvent, wherein the solvent comprises an alkane having at least 3 carbons and the weight ratio of the solvent to the steam is less than 1%.

21. The mixture of claim 14, further comprising a tertiary acetylenic diol.

22. A system for recovery of hydrocarbon from a reservoir of bituminous sands, the system comprising:
an injection well disposed in the reservoir for injecting steam into a region of the reservoir to soften bitumen in the region and generate a fluid comprising a hydrocarbon;
a production well disposed in the reservoir below the injection well for receiving the fluid to recover the hydrocarbon; and
a conduit in fluid communication with the reservoir, the conduit containing vapour of a compound for injection into the region,
wherein the compound is represented by 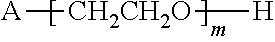
wherein
(i) m is 1, and A is —NH₂ or —N(H)CH₂CH₂OH; or
(ii) m is 1 or greater than 1, and A is —OR₁, R₁ being an alkyl group.

23. The system of claim 22, wherein the conduit is provided in the injection well.

24. The system of claim 22, wherein the compound is a primary, secondary, or tertiary alcohol ethoxylate.

25. The system of claim 22, wherein R₁ is a linear or branched alkyl group having more than 5 carbon atoms, and m is greater than 1.

26. The system of claim 24, wherein the alcohol ethoxylate has the formula of
C₁₂₋₁₄H₂₅₋₂₉O[CH₂CH₂O]₉H;
C₁₂₋₁₅H₂₅₋₃₁O[CH₂CH₂O]_{2.8}H; 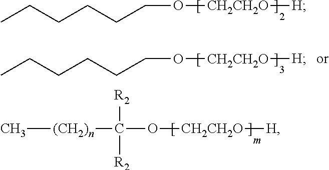
wherein
m is 2 or 3,
n is 2 or 3, and
R₂ is methyl or ethyl.

27.-82. (canceled)
